(19) United States
(12) Patent Application Publication
(10) Pub. No.: US 2026/0330799 A1
(43) Pub. Date: Oct. 22, 2026

(54) IMAGE PROCESSING APPARATUS FOR RECOGNIZING OBJECT IN PICKED-UP IMAGE, IMAGE PROCESSING SYSTEM, CONTROL METHOD FOR IMAGE PROCESSING APPARATUS, AND STORAGE MEDIUM

(71) Applicant: CANON KABUSHIKI KAISHA, Tokyo (JP)

(72) Inventors: KENTA TACHIKAWA, Kanagawa (JP); AKIRA KOSUGE, Tokyo (JP)

(21) Appl. No.: 19/695,172

(22) Filed: Jun. 2, 2026

Related U.S. Application Data
(63) Continuation of application No. PCT/JP2024/036808, filed on Oct. 16, 2024.

(30) Foreign Application Priority Data
Dec. 13, 2023 (JP) 2023-210167

(51) Int. Cl. G06V 10/32; G06T 3/4046; G06T 7/73; G06V 10/22; G06V 10/764; G06V 10/82

(52) U.S. Cl. CPC G06V 10/32; G06T 3/4046; G06T 7/75; G06V 10/235; G06V 10/764; G06V 10/82; G06T 2207/20081; G06T 2207/30224; G06V 2201/07

(57) ABSTRACT

An image processing apparatus is provided for recognizing a predetermined scene in a picked-up image. The image processing apparatus generates distortion information indicating distortion, relative to a known shape, in a shape of a first object in a picked-up image, and calculates a target position in the picked-up image. The image processing apparatus determines a target region based on the generated distortion information and the calculated target position, and uses the determined target region to generate a target region image from the picked-up image. The image processing apparatus scales the generated target region image to a predetermined size, and performs predetermined recognition based on the scaled target region image. In determining the target region, a size of the target region corresponding to an actual size is determined based on the generated distortion information and the calculated target position.

### CROSS-REFERENCE TO RELATED APPLICATIONS

This application is a Continuation of International Patent Application No. PCT/JP2024/036808, filed Oct. 16, 2024, which claims the benefit of Japanese Patent Application No. 2023-210167, filed Dec. 13, 2023, both of which are hereby incorporated by reference herein in their entirety.

### BACKGROUND

### Field of the Technology

The present disclosure relates to image processing apparatuses for recognizing an object in a picked-up image, image processing systems, and control methods and storage media for the image processing apparatuses.

### Description of the Related Art

These days, in sports and other image pick up situations, there are needs for automatic image pickup of highlight scenes during matches. For example, in basketball, a highlight scene can be a scene of a player taking a shot. To automatically pick up an image of a shot scene, for example, one method involves determining whether a player is taking a shot based on the positional relationship between the ball and the player, as well as the state of the player's posture, derived from image pickup data of a camera, and then performing image pickup control on the camera for the player taking the shot.

A known method for estimating the player's posture from image pickup data involves detecting “player's joint coordinates”. For detecting “player's joint coordinates”, a method using a trained posture estimation model (a posture estimation model) is known. Specifically, this method involves inputting an image of a player into the posture estimation model, which then outputs the coordinates of joints such as the top of the head, the neck, the wrists, the elbows, the shoulders, and the waist of the player, thereby obtaining the “joint coordinates”. In a case where a posture of a player is estimated with basketball taken as an example, inputting image pickup data covering the entire basketball court into the “posture estimation model” results in long processing time due to the high input resolution, which is unsuitable for real-time processing. To counter this, a known method involves lowering the input resolution and shortening the processing time by reducing or downscaling the image pickup data before inputting the image pickup data into the “posture estimation model”.

In a case where the image pickup data is reduced, the resolution of the player appearing in the image pickup data also drops with the reduction accordingly, which may prevent the accurate detection of the players' joint coordinates. That is, it may prevent the determination whether the player is taking a shot. To counter this, Japanese Patent Laid-Open (kokai) No. 2020-054748 discloses a method for performing predetermined recognition at high speed while increasing the resolution of inputs to trained models including a posture estimation model. Japanese Patent Laid-Open (kokai) No. 2020-054748 discloses a technique for detecting the coordinates of a ball from image pickup data, and then determining an action of a player from an image cropped to the vicinity of the ball. Because there is a high possibility that a player performs a predetermined action in the vicinity of the ball in certain kinds of sports, it becomes possible to determine an action of a player from the coordinates of the ball and the joint coordinates of the player, using this technique.

However, in a case where image pickup is performed so that the image covers the entire basketball court, players far from the camera appear small in the image, and players close to the camera appear large in the image. In the conventional technique disclosed in Japanese Patent Laid-Open (kokai) No. 2020-054748, the cropping size is always the same. Therefore, there is a possibility that a player close to the camera will be cut off when cropping is based on a player far from the camera. Since the “cut-off portion” is not used for detection of the player's joint coordinates, it is difficult to estimate the postures of the players with high accuracy. On the other hand, when cropping is based on a player close to the camera, there is a possibility that the resolution of a player far from the camera will become lower. Low resolution makes it difficult to recognize the players with high accuracy, as the resolution is further lowered by the reduction process performed before inputting data into a trained model. In a case where predetermined recognition is performed using data obtained by picking up an image of a wide area such as a basketball court, cropping to a fixed size without taking into account the distance between the camera and the subject (a player or the like) results in cropping that is not suitable for the recognition. As a result, recognition accuracy drops.

### SUMMARY

The present disclosure is directed to provide image processing apparatuses, image processing systems, control methods, and storage media that enable highly accurate recognition of a predetermined action performed by an object in a picked-up image, regardless of the position of the object in the image-pickup angle of view.

According to an aspect of the present disclosure, an image processing apparatus for recognizing a predetermined scene in a picked-up image, includes one or more processors; and at least one memory coupled to the one or more processors. The at least one memory stores instructions that, when executed by the one or more processors, cause the one or more processors to perform the following operations. The operations include: receiving a picked-up image obtained by picking up an image of a first object; generating distortion information indicating distortion, relative to a known shape, in a shape of the first object in the received picked-up image; and calculating a target position in the picked-up image. The operations further include: determining a target region based on the generated distortion information and the calculated target position; based on the determined target region, generating a target region image from the picked-up image; scaling the generated target region image to a predetermined size; and performing predetermined recognition based on the scaled target region image. In determining the target region, a target region size that is a size of the target region corresponding to an actual size is determined based on the generated distortion information and the calculated target position.

According to another aspect of the present disclosure, an image processing system includes a first camera configured to pick up a picked-up image of a first object; a second camera configured to perform image pickup in a designated image pickup direction; and the above image processing apparatus. The first camera includes: a first image pickup unit that acquires a picked-up image of the first object; and a transmitter that transmits the picked-up image acquired by the first image pickup unit to the image processing apparatus. The operations performed by the one or more processors of the image processing apparatus further include: generating a control signal for directing the second camera in an image pickup direction corresponding to a result of performing the predetermined recognition; and transmitting the generated control signal to the second camera. The second camera includes: a second image pickup unit that performs image pickup; a receiver that receives the control signal transmitted from the image processing apparatus; and a controller that controls an image pickup direction of the second image pickup unit based on the control signal received by the receiver.

According to another aspect of the present disclosure, a control method for an image processing apparatus for recognizing a predetermined scene in a picked-up image, includes: receiving a picked-up image obtained by picking up an image of a first object; generating distortion information indicating distortion, relative to a known shape, in a shape of the first object in the received picked-up image; and calculating a target position in the picked-up image. The control method further includes: determining a target region based on the generated distortion information and the calculated target position; based on the determined target region, generating a target region image from the picked-up image; scaling the generated target region image to a predetermined size; and performing predetermined recognition based on the scaled target region image. In determining the target region, a target region size that is a size of the target region corresponding to an actual size, is determined based on the generated distortion information and the calculated target position.

Features of the present disclosure will become apparent from the following description of embodiments with reference to the attached drawings.

### BRIEF DESCRIPTION OF THE DRAWINGS

FIG. 1 is a configuration diagram of an image processing system according to first to third embodiments.

FIG. 2 is a hardware configuration diagram of the image processing system according to the first to third embodiments.

FIG. 3 is a functional configuration diagram of the image processing system according to the first to third embodiments.

FIG. 4A is a flowchart illustrating a process to be performed by an overview camera according to the first to third embodiments.

FIG. 4B is a flowchart illustrating a process to be performed by an image processing apparatus according to the first to third embodiments.

FIG. 4C is a flowchart illustrating a process to be performed by a targeting camera according to the first to third embodiments.

FIG. 5A is an explanatory diagram of an overview image signal according to the first to third embodiments.

FIG. 5B is an explanatory diagram of a target region image signal according to the first to third embodiments.

FIG. 5C is an explanatory diagram of a reduced image signal according to the first to third embodiments.

FIG. 6 is a flowchart illustrating a target region image generation process according to the first embodiment.

FIG. 7 is an explanatory diagram of the target region image generation process according to the first embodiment.

FIG. 8 is a flowchart illustrating a target region image generation process according to the second embodiment.

FIG. 9A is an explanatory diagram (a side perspective view) of the target region image generation process according to the second embodiment.

FIG. 9B is an explanatory diagram (a top perspective view) of the target region image generation process according to the second embodiment.

FIG. 10 is a flowchart illustrating a target region image generation process according to the third embodiment.

FIG. 11A is an explanatory diagram (a perspective view) of the target region image generation process according to the third embodiment.

FIG. 11B is an explanatory diagram (a plan view) of the target region image generation process according to the third embodiment.

### DESCRIPTION OF THE EMBODIMENTS

Embodiments of the present disclosure will be described in detail below with reference to the accompanying drawings. It should be noted that, in the accompanying drawings, the same or similar components are denoted by the same reference numerals, and repetitive descriptions will be omitted.

First, the first embodiment according to the present disclosure is described. In the first embodiment, an image pickup target is basketball, and a description is given of a process of determining whether a shot scene occurs from image pickup data including the entire basketball court and of picking up a video image including the shot scene. It should be noted that the image pickup target is not limited to basketball and may be any image pickup target. In the following description, the players are denoted by 109, and the ball is denoted by 110. In a description for a plurality of objects, only numbers are used to represent the entire objects, and a number to which an alphabet is added as in “109a” is used when an individual object is to be identified in the explanation.

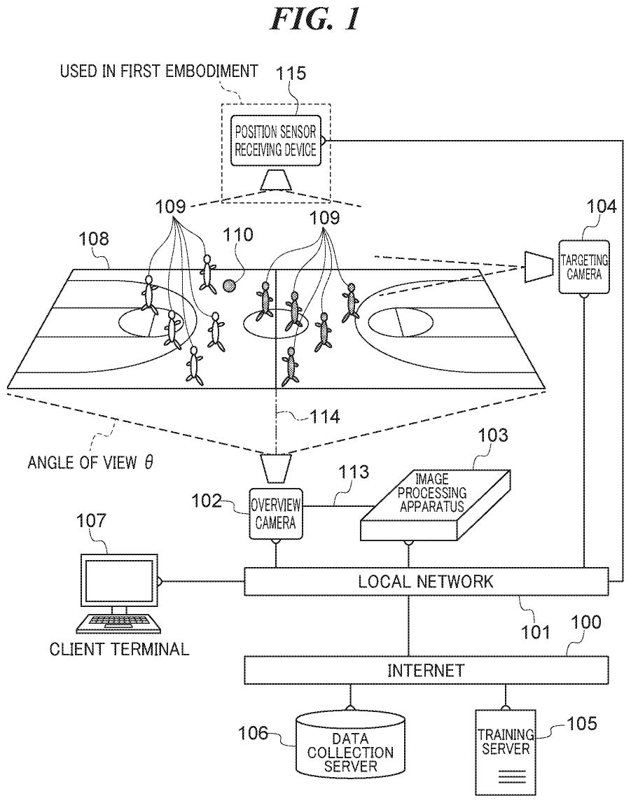

FIG. 1 is a configuration diagram of an image processing system including an image processing apparatus 103 that performs a shot scene determining process according to the first embodiment. The image processing system includes the Internet 100, a local network 101, an overview camera 102, the image processing apparatus 103, a targeting camera 104, a training server 105, a data collection server 106, and a client terminal 107. The image processing system also includes a position sensor receiving device 115 as appropriate.

The Internet 100 is a network for communicating necessary information with the training server 105, the data collection server 106, and the like. Also, the Internet 100 can communicate with electronic devices connected to the local network 101 via the local network 101. The local network 101 is a network for the overview camera 102, the image processing apparatus 103, the targeting camera 104, and the client terminal 107 to communicate necessary information with one another. Furthermore, the local network 101 can communicate necessary information with electronic devices connected to the Internet 100 via the Internet 100.

The overview camera 102 is a camera for picking up an image of an entire basketball court 108. Also, the overview camera 102 transmits the picked-up image to the image processing apparatus 103 through a video cable 113. In the present embodiment, it is assumed that the overview camera 102 is to pick up images at 30 frames per second (30 fps), but the frame rate is not limited to this value. Further, the image pickup optical axis 114 of the overview camera 102 is oriented parallel to the half-court line of the basketball court 108, and image pickup is performed at an “angle of view θ” within which the nearer sideline of the basketball court 108 falls.

The image processing apparatus 103 controls the targeting camera 104 when performing, on a picked-up image received from the overview camera 102, object detection with respect to a ball 110, posture estimation with respect to players 109, determination as to the presence/absence of a shot scene, and the like, to pick up the shot scene. The targeting camera 104 includes a pan-tilt mechanism, a zoom mechanism, and the like, and is a camera for picking up a shot scene, under the control of the image processing apparatus 103. In the present embodiment, it is assumed that the targeting camera 104 is to pick up images at 60 frames per second (60 fps), but the frame rate is not limited to this value.

The training server 105 is a server for generating a “trained model” to be used when the image processing apparatus 103 performs object detection and posture estimation. The training server 105 includes the following two trained models: a trained object detection model (hereinafter referred to as the “object detection model”) for detecting the ball 110 from image pickup data of the overview camera 102, and a trained posture estimation model of (hereinafter referred to as the “posture estimation model”) for estimating the joint coordinates of the players 109 from a target region image signal 601.

The data collection server 106 is a server that collects and accumulates supervised data for machine learning used for the training server 105 to generate a trained model. The client terminal 107 is a terminal that performs an operation on an electronic device connected to the Internet 100 and the local network 101, or issues an instruction to transmit and receive data. The type of the client terminal 107 is not limited to any particular type, and the client terminal 107 can be formed with a general-purpose PC, for example. The position sensor receiving device 115 reads ball position information from a position sensor attached to the ball 110, and measures the position of the ball 110 on the basketball court 108.

The above is a description of an example configuration of the system that performs a shot scene determination process according to the first embodiment. This system extracts the position of the ball 110, the postures of the players 109, and the like from a basketball game, then detects a shot scene based on the conditions of the ball 110 and the players 109, and automatically picks up an image of the shot scene.

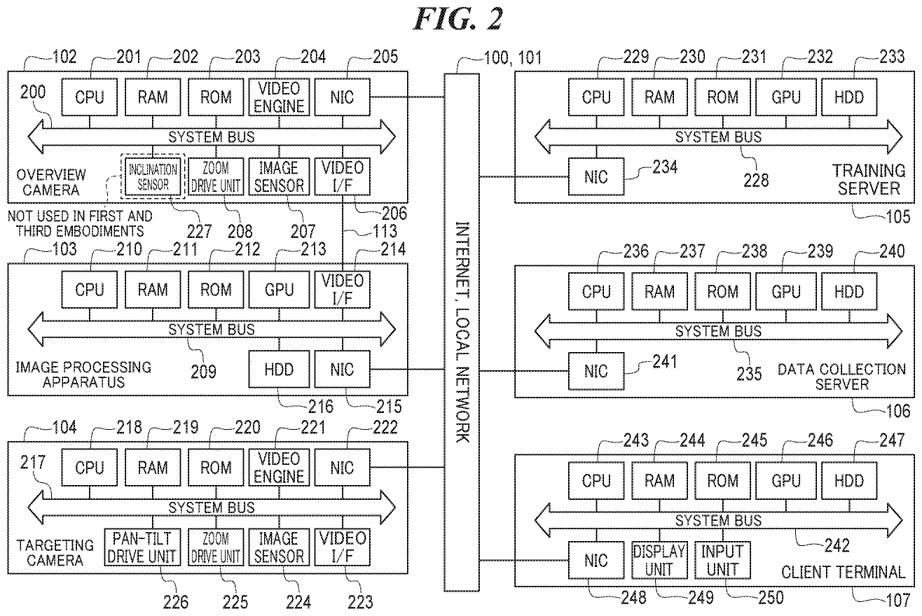

FIG. 2 is a hardware configuration diagram of the devices constituting the system in FIG. 1. The overview camera 102 includes a CPU 201, a RAM 202, a ROM 203, a video engine 204, an NIC 205, a video interface (I/F) 206, an image sensor 207, a zoom drive unit 208, and an inclination sensor 227. These components are connected to a system bus 200, and are designed to be able to transmit and receive necessary information to and from one another.

The CPU 201 controls the overview camera 102. The CPU 201 controls the units to be described later, and performs control operations such as image pickup using the image sensor 207 and transmission of image pickup data using the video I/F 206. The RAM 202 is a volatile memory in which stored information can be rewritten, and a work area for a program in which the contents of control of the overview camera 102 are written is formed therein. The RAM 202 is formed with a volatile memory (a DRAM or the like) using a semiconductor element, for example. The ROM 203 is a nonvolatile memory, and stores, in a nonvolatile manner, a program in which the contents of control of the overview camera 102 are written, and various kinds of parameters. The ROM 203 is formed with a flash memory, for example. In response to a user turning on the power to the overview camera 102, the CPU 201 reads the program from the ROM 203, loads the program into the RAM 202, and executes the program, so that control of the overview camera 102 is started.

The video engine 204 is an image processing engine that converts electric charge obtained from the image sensor 207 into an image signal. The NIC 205 is a network interface card (NIC), and is used for the overview camera 102 to communicate with other apparatuses via the local network 101. For example, communication based on a communication scheme standardized by Ethernet (registered trademark) or the IEEE802.3 series is performed. The video I/F 206 is an interface for connecting the overview camera 102 and the image processing apparatus 103 with the video cable 113.

The overview camera 102 transmits image pickup data to the image processing apparatus 103 via the video I/F 206. It should be noted that the video I/F 206 is not limited to any particular type, as long as it is an interface capable of communicating with the image processing apparatus 103. For example, a high-definition multimedia interface (HDMI, registered trademark) can be used. Also, the overview camera 102 may be a network camera, or may transmit image pickup data to the image processing apparatus 103 via the NIC 205.

The image sensor 207 is a sensor that receives light emitted from an image pickup target, and converts the brightness and the color of the light into electric charge. This sensor may be a photodiode, a charge coupled device (CCD) sensor, a complementary metal oxide semiconductor (CMOS) sensor, or the like, for example. The zoom drive unit 208 is a unit for changing the degree of “zoom” of the zoom lens included in the overview camera 102. The inclination sensor 227 is a sensor that detects an angle at which the main body of the overview camera 102 is inclined relative to the horizontal direction.

The image processing apparatus 103 includes a CPU 210, a RAM 211, a ROM 212, a GPU 213, a video interface (I/F) 214, an NIC 215, and an HDD 216. These components are connected to a system bus 209, and are designed to be able to transmit and receive necessary information to and from one another.

The CPU 210 controls the image processing apparatus 103. The CPU 210 controls the units to be described later, and performs operations corresponding to image pickup data received from the video I/F 206 or communication data received from the NIC 215. The RAM 211 is a volatile memory in which stored information can be rewritten, and a work area for a program in which the contents of control of the image processing apparatus 103 are written is formed therein. The RAM 211 is formed with a volatile memory (a DRAM or the like) using a semiconductor element, for example. The ROM 212 is a nonvolatile memory, and stores, in a nonvolatile manner, a program in which the contents of control of the image processing apparatus 103 are written, and various kinds of parameters. In response to a user turning on the power to the image processing apparatus 103, the CPU 210 reads the program from the ROM 212, loads the program into the RAM 211, and executes the program. Thus, control of the image processing apparatus 103 is started. The ROM 212 is formed with a flash memory or the like, for example.

The GPU 213 is a unit that performs parallel computation of data. In a case where a large number of product-sum operations are to be performed in an inference process, the GPU 213 is faster and more efficient in executing the processing than the CPU 210. Although an LSI called a “graphics processing unit” is normally used as the GPU 213, functions equivalent to those of the LSI may be formed with reconfigurable logic circuit hardware called an FPGA.

The video I/F 214 is an interface for connecting the overview camera 102 and the image processing apparatus 103 with the video cable 113. The image processing apparatus 103 receives image pickup data from the overview camera 102 via the video I/F 214. The video I/F 214 is not limited to any particular type, as long as it is an interface capable of communicating with the overview camera 102. For example, a universal serial bus (USB) interface or the like is used. The NIC 215 is a network interface card, and is used for the image processing apparatus 103 to communicate with other apparatuses via the local network 101. For example, communication based on a communication scheme standardized by Ethernet (registered trademark) or the IEEE802.3 series is performed.

The HDD 216 is a storage device that stores image pickup data received from the overview camera 102 and a “trained model” received from the training server 105. In the present embodiment, the HDD 216 is a hard disk drive (HDD) using a magnetic storage system, but the HDD 216 is not limited to this type. For example, an external storage device such as a solid-state drive (SSD) using a semiconductor element may be used as the HDD 216.

The targeting camera 104 includes a CPU 218, a RAM 219, a ROM 220, a video engine 221, an NIC 222, a video interface (I/F) 223, an image sensor 224, a zoom drive unit 225, and a pan-tilt drive unit 226. These components are connected to a system bus 217, and are designed to be able to transmit and receive necessary information to and from one another.

The CPU 218 controls the targeting camera 104. The CPU 218 controls the units to be described later, and conducts image pickup using the image sensor 224, communication data receiving operations using the NIC 222, and the like. The RAM 219 is a memory in which information can be rewritten, and a work area for a program in which the contents of control of the targeting camera 104 are written is formed therein. The RAM 219 is formed with a volatile memory using a semiconductor element, for example. The ROM 220 is a nonvolatile memory, and stores, in a nonvolatile manner, a program in which the contents of control of the targeting camera 104 are written, and various kinds of parameters. In response to a user turning on the power to the targeting camera 104, the CPU 218 reads the program from the ROM 220, loads the program into the RAM 219, and executes the program. Thus, control of the targeting camera 104 is started. The ROM 220 is formed with a flash memory, for example.

The video engine 221 is an image processing engine that converts electric charge obtained from the image sensor 224 into an image signal. The NIC 222 is a network interface card, and is used for the targeting camera 104 to communicate with other apparatuses via the local network 101. For example, communication based on a communication scheme standardized by Ethernet (registered trademark) or the IEEE802.3 series is performed. The video I/F 223 is an interface for transmitting image pickup data of the targeting camera 104. In a case where a video image of a basketball game is picked up with this system, image pickup data transmitted from the video I/F 223 is a video image of a desired highlight scene. Therefore, the video I/F 206 is used to connect an external storage device (not illustrated) or the like for storing video images of highlight scenes. It should be noted that the video I/F 206 is not limited to any particular type, as long as it is an interface that can communicate with the image processing apparatus 103. For example, an HDMI interface may be used for the video I/F 206.

The image sensor 224 is a sensor that receives light emitted from the image pickup target, and converts the brightness and the color of the light into electric charge. This sensor may be a photodiode, a CCD sensor, a CMOS sensor, or the like, for example. The zoom drive unit 225 is a unit for changing the degree of “zoom” of the zoom lens included in the targeting camera 104. The pan-tilt drive unit 226 is a unit for changing the degree of turning of a pan-turning mechanism and a tilt-turning mechanism included in the targeting camera 104.

The training server 105 includes a CPU 229, a RAM 230, a ROM 231, a GPU 232, an HDD 233, and an NIC 234, and these components are designed to be able to transmit and receive necessary information to and from one another via a system bus 228. The CPU 229 controls the training server 105. The CPU 229 controls the units to be described later, and performs operations corresponding to communication data received from the NIC 234. The RAM 230 is a memory in which information can be rewritten, and a work area for a program in which the contents of control of the training server 105 are written is formed therein. The RAM 230 is formed with a volatile memory using a semiconductor element, for example. The ROM 231 is a nonvolatile memory, and stores, in a nonvolatile manner, a program in which the contents of control of the training server 105 are written, various kinds of parameters, and the like. In response to a user turning on the power to the training server 105, the CPU 229 reads the program from the ROM 231, loads the program into the RAM 230, and executes the program, so that control of the training server 105 is started. The ROM 231 is formed with a flash memory, for example.

The GPU 232 is a unit that performs parallel computation of data, and performs efficient computation by performing parallel processing of a larger amount of data. Accordingly, in a case where training is conducted a plurality of times using a training model for deep learning or the like, it is effective that the GPU 232 performs the processing. In the present embodiment, in a training process by the training server 105, the GPU 232 is used in addition to the CPU 229. Specifically, in a case where a training program including a training model is executed, the CPU 229 and the GPU 232 perform computation in cooperation to perform training. It should be noted that the training process may be performed by only one of the CPU 229 and the GPU 232. Although the GPU 232 is formed with an LSI called a “graphics processing unit”, for example, functions equivalent to those of the LSI may be formed with reconfigurable logic circuit hardware called an FPGA.

The HDD 233 is a storage device that stores, in a nonvolatile manner, supervised data received from the data collection server 106, a trained model that has learned from the supervised data, and the like. In the present embodiment, the HDD 233 is a hard disk drive using a magnetic storage system, but the HDD 233 is not limited to this type. For example, an external storage device such as a solid-state drive using a semiconductor element may be used as the HDD 233. The NIC 234 is a network interface card, and is used for the training server 105 to communicate with other apparatuses via the Internet 100. For example, communication based on a communication scheme standardized by Ethernet (registered trademark) or the IEEE802.3 series is performed.

The data collection server 106 includes a CPU 236, a RAM 237, a ROM 238, a GPU 239, an HDD 240, and an NIC 241, and these components are designed to be able to transmit and receive necessary information to and from one another via a system bus 235. The CPU 236 controls the data collection server 106. The CPU 236 controls the units to be described later, and performs operations corresponding to communication data received from the NIC 241. The RAM 237 is a memory in which information can be rewritten, and a work area for a program in which the contents of control of the data collection server 106 are written is formed therein. The RAM 237 is formed with a volatile memory using a semiconductor element, for example.

The ROM 238 is a nonvolatile memory, and stores, in a nonvolatile manner, a program in which the contents of control of the data collection server 106 are written, various kinds of parameters, and the like. In response to a user turning on the power to the data collection server 106, the CPU 236 reads the program from the ROM 238, loads the program into the RAM 237, and executes the program, so that control of the data collection server 106 is started. The ROM 238 is formed with a flash memory, for example. The GPU 239 is a unit that performs parallel computing of data. Although the GPU 239 is normally formed with an LSI called a “graphics processing unit”, functions equivalent to those of the LSI may be formed with reconfigurable logic circuit hardware called an FPGA.

The HDD 240 is a storage device that stores the supervised data requested from the training server 105. Although the HDD 240 is a hard disk drive using a magnetic storage system in the present embodiment, the HDD 240 is not limited to any particular type, and a storage device such as a solid-state drive using a semiconductor element may be used as the HDD 240. The NIC 241 is a network interface card, and is used for the data collection server 106 to communicate with other apparatuses via the Internet 100. For example, communication based on a communication scheme standardized by Ethernet (registered trademark) or the IEEE802.3 series is performed.

The client terminal 107 includes a CPU 243, a RAM 244, a ROM 245, a GPU 246, an HDD 247, an NIC 248, a display unit 249, and an input unit 250. These components are designed to be able to transmit and receive necessary information to and from one another via a system bus 242. The CPU 243 controls the client terminal 107. The CPU 243 controls the units to be described later, and performs operations corresponding to data input from the input unit 250 or communication data received from the NIC 241. The RAM 244 is a memory in which information can be rewritten, and a work area for a program in which the contents of control of the client terminal 107 are written is formed therein. The RAM 244 is formed with a volatile memory using a semiconductor element, for example.

The ROM 245 is a nonvolatile memory, and stores, in a nonvolatile manner, a program in which the contents of control of the client terminal 107 are written, and various kinds of parameters. In response to a user turning on the power to the client terminal 107, the CPU 243 reads the program from the ROM 245, loads the program into the RAM 244, and executes the program. Thus, control of the client terminal 107 is started. The ROM 245 is formed with a flash memory, for example. The GPU 246 is a unit that performs parallel computing of data, and is used to display, on the display unit 249, image data received from the image processing apparatus 103 via the NIC 248. Although the GPU 246 is normally formed with an LSI called a “graphics processing unit”, functions equivalent to those of the LSI may be formed with reconfigurable logic circuit hardware called an FPGA.

The HDD 247 is a storage device that stores, in a nonvolatile manner, image data received from the image processing apparatus 103 via the NIC 248. In the present embodiment, the HDD 247 is a hard disk drive using a magnetic storage system, but the HDD 247 is not limited to this type. A storage device such as a solid-state drive using a semiconductor element may be used as the HDD 247. The NIC 248 is a network interface card, and is used for the client terminal 107 to communicate with other apparatuses via the local network 101. For example, communication based on a communication scheme standardized by Ethernet (registered trademark) or the IEEE802.3 series is performed. The display unit 249 is a display device that displays image data received from the image processing apparatus 103 via the NIC 248. The display unit 249 is formed with a liquid crystal display (LCD), for example. The input unit 250 is an input device that receives an operation and an instruction from a user who uses this system. The input unit 250 is formed with a pointing device such as a mouse, and an input device such as a keyboard, for example.

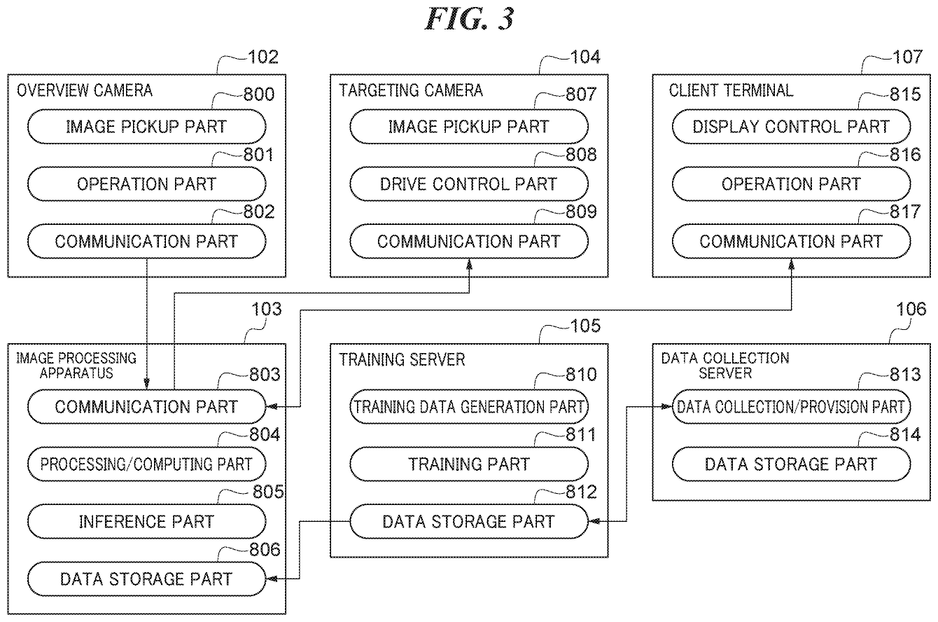

FIG. 3 is a functional configuration diagram of software realized through the cooperation between the hardware illustrated in the hardware configuration diagram in FIG. 2 and programs. It should be noted that general-purpose software such as an OS is not illustrated in the functional configuration of this software.

The overview camera 102 includes an image pickup part 800, an operation part 801, and a communication part 802. These functional parts are implemented by the CPU 201 loading a program stored in the ROM 203 into the RAM 202 and executing the program. In the image pickup part 800, the CPU 201 controls the video engine 204, the image sensor 207, and the zoom drive unit 208 to acquire image pickup data of an angle of view θ covering the entire basketball court 108. In the operation part 801, the CPU 201 controls the NIC 205 to perform an operation such as starting image pickup or stopping image pickup, in accordance with an instruction received from the client terminal 107. In the communication part 802, the CPU 201 controls the NIC 205 and the video I/F 206 to transmit image pickup data and camera information to the image processing apparatus 103.

The image processing apparatus 103 includes a communication part 803, a processing/computing part 804, an inference part 805, and a data storage part 806. These functional parts are implemented by the CPU 210 loading a program stored in the ROM 212 into the RAM 211 and executing the program. In the communication part 803, the CPU 210 controls the video I/F 214 and the NIC 215 to receive data from the overview camera 102 and the training server 105, or transmit data to the targeting camera 104. In the processing/computing part 804, the CPU 210 performs image processing such as a reduction process and Hough transform on image pickup data received from the overview camera 102. Also, in the processing/computing part 804, the CPU 210 cuts out an image from the image pickup data, depending on a result of inference performed by the inference part 805 to be described later. Further, the processing/computing part 804 determines whether there is a shot scene in the image based on the cut-out image, or calculates control values for the targeting camera 104.

In the inference part 805, the CPU 210 controls the GPU 213 to perform an inference process for object detection and posture estimation on the “image pickup data” received from the overview camera 102, using a “trained model” trained by the training server 105. It should be noted that, in “an object detection model inference”, image data including the ball 110 is set as the input data, and the “rectangular coordinates” circumscribing the ball 110 in the above-mentioned “image pickup data” are set as the output data. Meanwhile, in “a posture estimation model inference”, image data including players 109 is set as the input data, and the “joint coordinates” of the players 109 in the above-mentioned “image pickup data” are set as the output data. In the data storage part 806, the CPU 210 controls the HDD 216 to store and manage the trained model received from the training server 105.

The targeting camera 104 includes an image pickup part 807, a drive control part 808, and a communication part 809. These functional parts are implemented by the CPU 218 loading a program stored in the ROM 220 into the RAM 219 and executing the program. In the image pickup part 807, the CPU 218 controls the video engine 221, the image sensor 224, and the zoom drive unit 225 to pick up an image having an angle of view that covers the players 109 and the ball 110. In the drive control part 808, the CPU 218 controls the pan-tilt drive unit 226 and the zoom drive unit 225 to adjust the amount of turning of the pan-tilt mechanism and the amount of zoom of the zoom lens in accordance with an instruction received from the image processing apparatus 103. In the communication part 809, the CPU 218 controls the NIC 205 and the video I/F 206 to receive the respective control values for the pan-tilt drive unit 226 and the zoom drive unit 225 from the image processing apparatus 103.

The data collection server 106 includes a data collection/provision part 813 and a data storage part 814. These functional parts are implemented by the CPU 236 loading a program stored in the ROM 238 into the RAM 237 and executing the program.

As the CPU 236 controls the NIC 241, the data collection/provision part 813 has a function of collecting “supervised data” requested by the training server 105 from the Internet 100, and a function of transmitting the collected “supervised data” to the training server 105. It should be noted that, in the present embodiment, an image including the ball 110 and the “position coordinates” of the ball 110 in the image are used as the “supervised data” for object detection. Also, as the “supervised data” for posture estimation, a “training data set for posture estimation” including a combination of an image in which the entire body of a person appears and the position coordinates of each of the joints of the person appearing in the image is used. In the data storage part 814, the CPU 236 controls the HDD 240 to store and manage the supervised data collected from the Internet 100.

The client terminal 107 includes a display control part 815, an operation part 816, and a communication part 817. These functional parts are implemented by the CPU 243 loading a program stored in the ROM 245 into the RAM 244 and executing the program.

In the display control part 815, the CPU 243 controls the display unit 249 to display, on the display unit 249, image data received from the image processing apparatus 103. In the operation part 816, the CPU 243 controls the input unit 250 to receive an operation or an instruction from a user using the image processing system. In the communication part 817, the CPU 243 controls the NIC 248 to transmit control commands to devices connected to the Internet 100 and the local network 101.

The training server 105 includes a training data generation part 810, a training part 811, and a data storage part 812. These functional parts are implemented by the CPU 229 loading a program stored in the ROM 231 into the RAM 230 and executing the program.

In the training data generation part 810, the CPU 229 generates training data by performing data augmentation on the “supervised data” received from the data collection server 106. In the “data augmentation”, first, an image transform process such as affine transform is performed on an image of the supervised data and the ground truth data corresponding to the image. As a result, an image different from the original image is generated. Information about the ground truth data is also transformed in conjunction with the image transform, and the number of pieces of training data increases.

In the training part 811, the CPU 229 controls the GPU 232 to perform training with both a “training model for object detection” and a “training model for posture estimation” and generate the respective trained models for object detection and posture estimation. It should be noted that examples of specific algorithms of machine learning that is performed with training models include the nearest neighbor method, the naive Bayes method, a decision tree, a support vector machine, and the like. Further, deep learning that automatically generates feature amounts and connection weighting coefficients for learning using a neural network is also taken as an example of a training model. From among the above-mentioned algorithms, available algorithms can be selected as appropriate, and be applied to the present embodiment.

It should be noted that the training part 811 may include an “error detection part” and an “update part”. The “error detection part” obtains an error between the supervised data and output data that is output from the output layer of the neural network in response to input data that is input to the input layer. Further, the “error detection part” may calculate an error between the supervised data and the output data from the neural network, using a loss function. The “update part” updates the connection weighting coefficients between the nodes of the neural network so that the error becomes smaller on the basis of the error calculated by the error detection part. The “update part” updates the connection weighting coefficients or the like, using an error back-propagation method, for example. Here, the error back-propagation method is a method for adjusting the connection weighting coefficients or the like between the nodes of each neural network so as to reduce errors.

In the data storage part 812, the CPU 229 controls the HDD 233 to store and manage the supervised data received from the data collection server 106, and the trained models trained by the training part 811.

Next, conditions and operations that constitute the premise of a processing flow are described before a specific processing flow in the present image processing system is described. The processing flow in the image processing system is executed on the assumption that an “object detection model” and a “posture estimation model” trained by the training server 105 are already stored in the HDD 216 of the image processing apparatus 103. Thus, the image processing apparatus 103 does not need to request a trained model each time it performs processing according to the present embodiment, and can execute each inference process using the “trained models” stored in the HDD 216.

Here, a method for preparing a trained model is described, with an “object detection model” being taken as an example. The basic operations of the client terminal 107, the data collection server 106, and the image processing apparatus 103 are also the same when a trained model is prepared.

Before starting a process according to the present embodiment, the CPU 243 of the client terminal 107 requests the following from the CPU 229 of the training server 105 via the NIC 248 of the client terminal 107. Specifically, the CPU 243 of the client terminal 107 requests generation of an “object detection model” that detects the ball 110 from a reduced image signal 604 of an overview image signal 600.

Next, the CPU 229 of the training server 105 requests the CPU 236 of the data collection server 106 to collect “supervised data” including the ball 110, via the NIC 234 of the training server 105. The CPU 236 of the data collection server 106 then collects “supervised data” including the ball 110 via the Internet 100.

Next, the CPU 236 of the data collection server 106 transmits the collected supervised data to the training server 105. The CPU 229 of the training server 105 generates training data by performing data augmentation on the supervised data received from the data collection server 106. The CPU 229 of the training server 105 then controls the GPU 232 of the training server 105, to generate an “object detection model” based on the generated training data. The CPU 229 of the training server 105 then transmits the generated trained model to the image processing apparatus 103. The CPU 210 of the image processing apparatus 103 stores the “trained model” received from the training server 105 into the HDD 216.

The above is a description of the method for preparing an “object detection model” for detecting the ball 110. It should be noted that, a method for creating a “pose estimation model” can be achieved by preparing “image data” including the players 109 and “joint coordinate data” of the players 109 as the “supervised data” by the method described above, and then performing training using a network model for posture estimation.

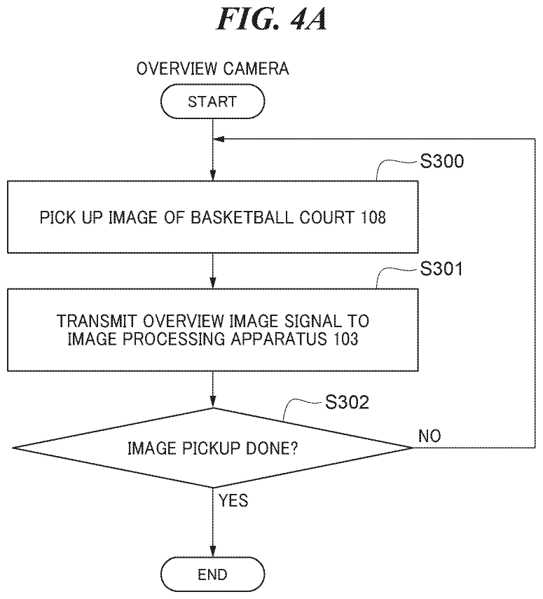

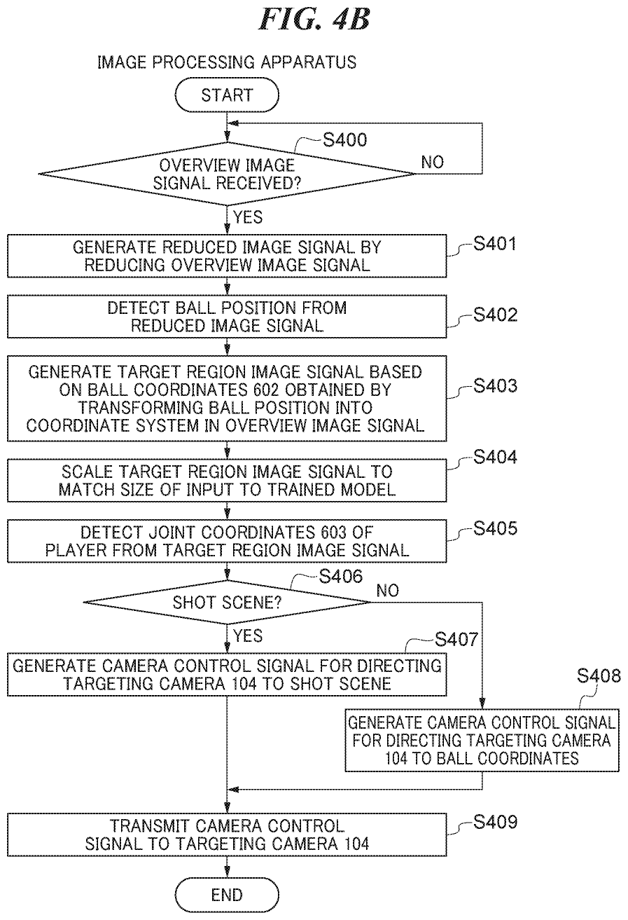

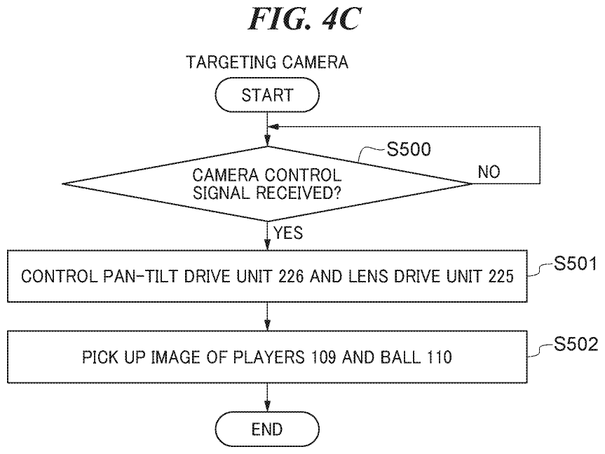

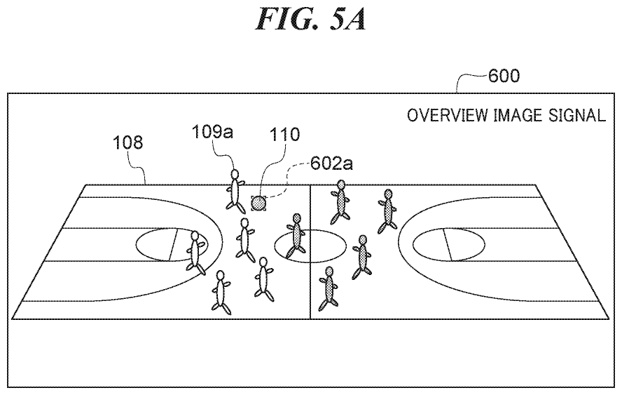

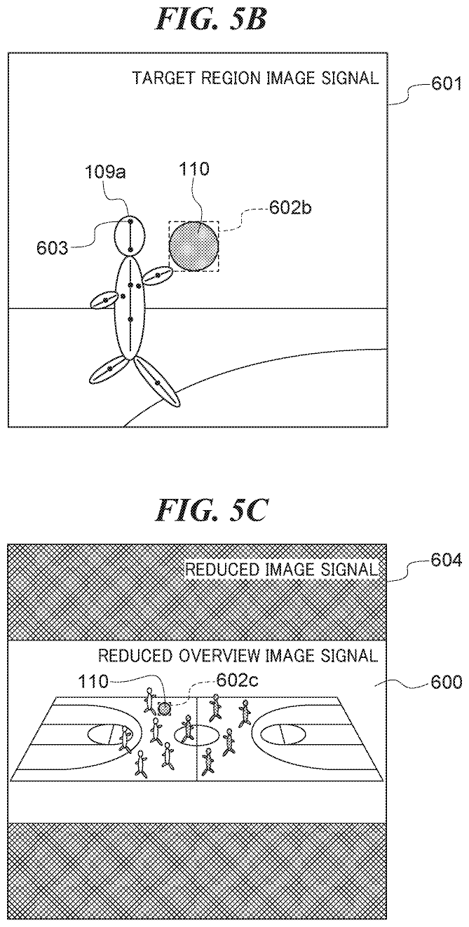

Next, specific processes to be performed in the present system are described with reference to FIGS. 4A to 5C. It should be noted that FIGS. 5A, 5B, and 5C are explanatory diagrams schematically illustrating the contents to be described with reference to FIGS. 4A, 4B, and 4C. FIG. 4A is a flowchart illustrating a process to be performed by the overview camera 102, and illustrates a process to be performed by the image pickup part 800, the operation part 801, and the communication part 802 in FIG. 3. In the following, a process to be performed by the overview camera 102 is described with reference to FIG. 4A.

First, the CPU 201 reads the software for the image pickup part 800 from the ROM 203, loads the software into the RAM 202, and carries out step S300. Specifically, in step S300, the CPU 201 controls the video engine 204 and the image sensor 207, and generates image pickup data having an angle of view θ to cover the entire basketball court 108 (this data will be hereinafter referred to as the “overview image signal 600”). It should be noted that FIG. 5A is an explanatory diagram of the overview image signal 600. After that, the CPU 201 stores the generated overview image signal 600 into the RAM 202 and makes the process proceed to step S301.

Next, the CPU 201 reads the software for the communication part 802 from the ROM 203, loads the software into the RAM 202, and carries out step S301. Specifically, in step S301, the CPU 201 transmits the overview image signal 600 stored into the RAM 202 in step S300, to the image processing apparatus 103 via the video I/F 206. The CPU 201 then makes the process proceed to step S302.

Next, the CPU 201 reads the software for the operation part 801 from the ROM 203, loads the software into the RAM 202, and carries out step S302. Specifically, in step S302, the CPU 201 determines (judges) whether there is an operation from a user interface (UI) (not illustrated) of the overview camera 102, or an instruction to end the image pickup from the client terminal 107 via the NIC 205. If it is determined that there is an instruction to end the image pickup (YES), the CPU 201 ends the image pickup. If it is determined that there are no instructions to end the image pickup (NO), on the other hand, the CPU 201 returns the process to step S300, and repeats the processing in steps S300 and S301.

FIG. 4B is a flowchart illustrating a process to be performed by the image processing apparatus 103, and is a diagram illustrating a process to be performed by the communication part 803, the processing/computing part 804, the inference part 805, and the data storage part 806 in FIG. 3. In the following, a process to be performed by the image processing apparatus 103 is described with reference to FIG. 4B. First, the CPU 210 reads the software for the communication part 803 from the ROM 212, loads the software into the RAM 211, and carries out step S400. Specifically, in step S400, the CPU 210 determines whether the overview image signal 600 (see FIG. 5A) transmitted from the overview camera 102 in step S301 has been received via the video I/F 214. If it is determined that the overview image signal 600 has been received (YES), the CPU 210 stores the overview image signal 600 into the RAM 211, and makes the process proceed to step S401. If it is determined that the overview image signal 600 has not been received (NO), on the other hand, the CPU 210 waits for reception of the overview image signal 600 in step S400.

Next, the CPU 210 reads the software for the processing/computing part 804 from the ROM 212, loads the software into the RAM 211, and carries out step S401. Specifically, in step S401, the CPU 210 reads the overview image signal 600 stored in the RAM 211 in step S400, and generates a reduced image signal 604 (see FIG. 5C) obtained by reducing the overview image signal 600. It should be noted that the factor for reduction (hereinafter referred to as the “reduction factor”) is a factor suitable for inputs to the trained model to be used for the inference process in the subsequent stage, but may be any factor designated by a user. The CPU 210 stores the generated reduced image signal 604 and the reduction factor into the RAM 211, and makes the process proceed to step S402.

Next, the CPU 210 reads the software for the inference part 805 from the ROM 212, loads the software into the RAM 211, and carries out step S402. Specifically, in step S402, the CPU 210 reads the “object detection model” from the HDD 216, and stores the read model into the RAM 211. After that, the CPU 210 controls the GPU 213 to read the reduced image signal 604 stored into the RAM 211 in step S401, and inputs the reduced image signal 604 to the “object detection model” stored into the RAM 211, to obtain “ball coordinates 602c”. After that, the CPU 210 stores the detected ball coordinates 602c into the RAM 211, and makes the process proceed to step S403. It should be noted that, in a case where the ball coordinates are not detected, the most recently detected ball coordinates may be used as the next ball coordinates. Alternatively, in a case where the ball coordinates are not detected, the movement locus may be predicted from the time series of the ball coordinates detected so far, and the predicted coordinates calculated from the prediction result may be used as the ball coordinates.

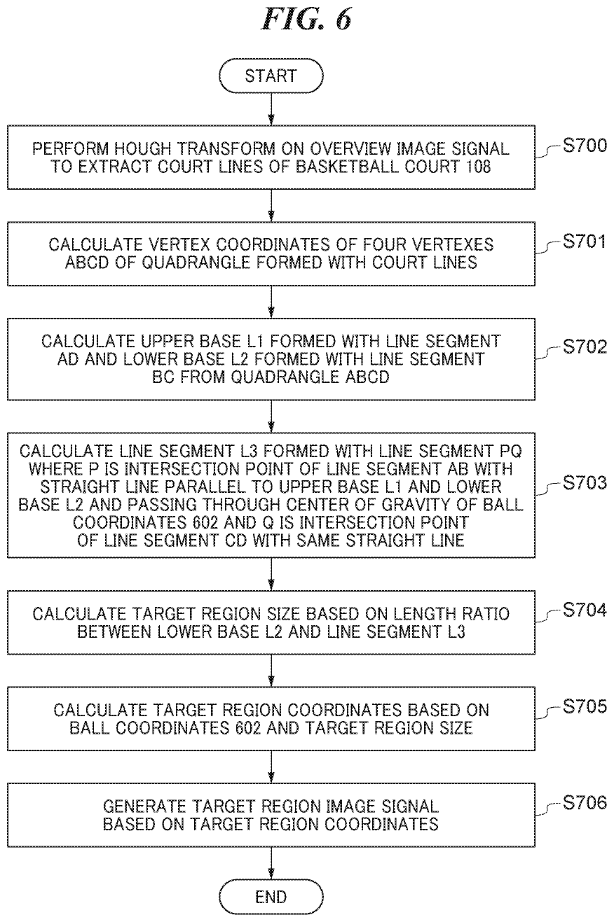

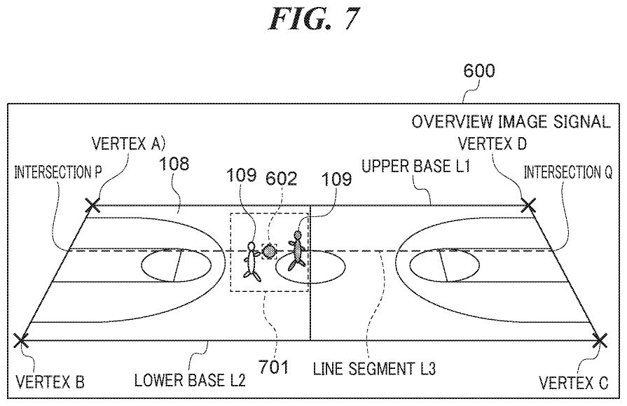

Next, the CPU 210 reads the software for the processing/computing part 804 from the ROM 212, loads the software into the RAM 211, and carries out step S403. Specifically, in step S403, the CPU 210 reads the ball coordinates 602c and the reduction factor that have been stored into the RAM 211 in step S402, and transforms the ball coordinates 602c in the reduced image signal 604 into ball coordinates 602a in the overview image signal 600, using the reduction factor. The CPU 210 then stores the transformed ball coordinates 602a into the RAM 211. After that, based on the ball coordinates 602a stored in the RAM 211, the CPU 210 crops the region including the ball 110 and the vicinity of the ball from the overview image signal 600, and generates the target region image signal 601 (see FIG. 5B). It should be noted that, the processing in step S403 includes the process of determining the cropping size, which will be described later in detail with reference to FIGS. 6 and 7. After that, the CPU 210 stores the generated target region image signal 601 into the RAM 211, and makes the process proceed to step S404.

Here, the target region image signal 601 is an image corresponding to the “target region size”, which is the size of the “target region”. The “target region” is a region in the picked-up image, corresponding to the place (the basketball court 108) being picked-up by the overview camera 102. The CPU 210 (a determination unit) determines the “target region” based on distortion information and the target position (ball coordinates 602). Also, the CPU 210 determines the “target region size” corresponding to the actual size based on the “distortion information” and the “target position”. Furthermore, as will be apparent in the description below, the “distortion information” is information indicating distortion of the shape of a first object (the basketball court 108) in the picked-up image picked-up by the overview camera 102 as compared with a known shape, and the CPU 210 generates the distortion information. There are target objects (second and third objects) in the target region image signal 601.

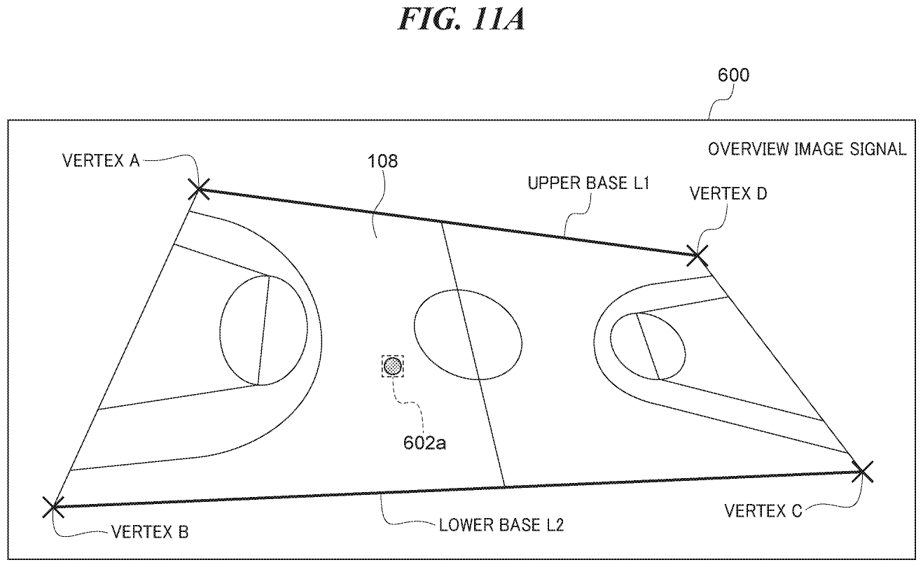

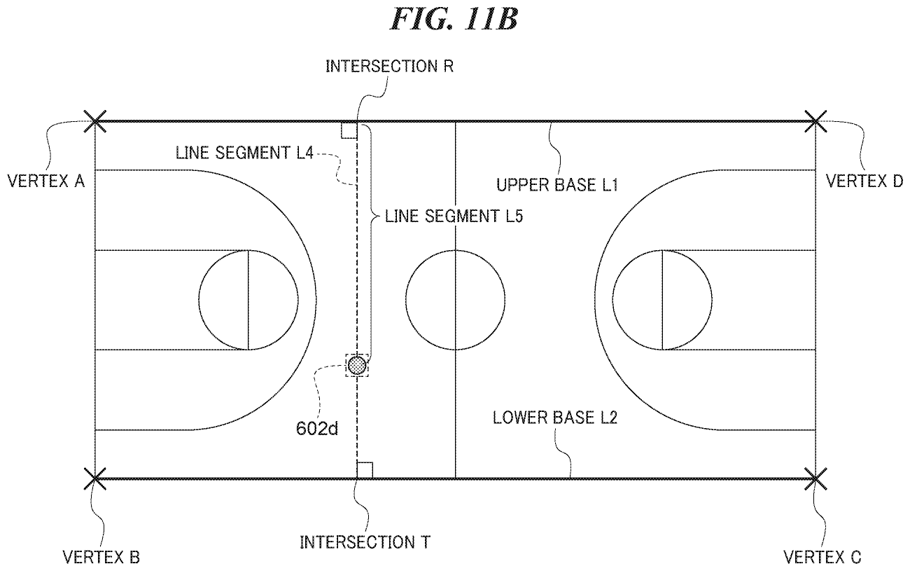

That is, to make the horizontally long rectangular basketball court 108 fit within the angle of view θ of the overview camera 102, the picked-up image is distorted into a quadrangular shape (a trapezoidal shape or the like) as illustrated in FIGS. 5A and 11A. Therefore, as an example (a third embodiment), the CPU 210 generates the “distortion information” based on a projective transform matrix between the coordinates indicating the vertexes of the first object (the basketball court 108) and the coordinates indicating the vertexes of the known shape of the first object. Here, the CPU 210 calculates the “target position (the ball coordinates 602)” in the picked-up image. The CPU 210 then determines the “target region” based on the “distortion information” and the calculated “target position”. Next, the CPU 210 determines the “target region size”, which is the size of the target region. The image corresponding to the “target region size” is an “target region image (the target region image signal 601)”. In embodiments of the present disclosure, the “target region” is specifically an image pickup region for picking up a shot scene, the ball, or the like. It should be noted that the CPU 210 can also determine the “target region” based on the position information (the joint coordinates) about the second object (a player 109) whose position is estimated in the image picked up by the overview camera 102.

After carrying out step S403, the CPU 210 then reads the software for the processing/computing part 804 from the ROM 212, loads the software into the RAM 211, and carries out step S404. Specifically, in step S404, the CPU 210 reads the target region image signal 601 stored into the RAM 211 in step S403, and scales the target region image signal 601 to match the size of an input to the posture estimation model. It should be noted that the factor for scaling is a factor suitable for inputs to a trained model to be used in the inference process, but may be any factor designated by a user. After that, the CPU 210 stores the scaled target region image signal 601 into the RAM 211, and makes the process proceed to step S405. As the target region image signal 601 is scaled (enlarged or reduced), the resolution of the target region image signal 601 changes.

Next, the CPU 210 reads the software for the inference part 805 from the ROM 212, loads the software into the RAM 211, and carries out step S405. Specifically, in step S405, the CPU 210 reads the “posture estimation model” from the HDD 216, and stores the read model into the RAM 211. After that, the CPU 210 controls the GPU 213 to read the target region image signal 601 stored into the RAM 211 in step S404, and detects “joint coordinates 603 (see FIG. 5B)” of a player 109a, using the “posture estimation model” stored in the RAM 211. It should be noted that, in a case where a plurality of players 109 appears in the target region image signal 601, joint coordinates 603 are detected for each of the players 109. The CPU 210 stores the detected joint coordinates 603 into the RAM 211, and makes the process proceed to step S406.

Next, the CPU 210 reads the software for the processing/computing part 804 from the ROM 212, loads the software into the RAM 211, and carries out step S406. Specifically, in step S406, the CPU 210 determines whether the player 109a is taking a shot, based on the ball coordinates 602a stored into the RAM 211 in step S403, and the joint coordinates 603 stored into the RAM 211 in step S405. Specifically, the CPU 210 transforms the coordinate system of the ball coordinates 602a from the coordinate system in the overview image signal 600 into the coordinate system in the target region image signal 601, and stores the transformed ball coordinates 602b into the RAM 211.

The CPU 210 then reads the ball coordinates 602b and the joint coordinates 603 stored in the RAM 211, and compares the positional relationships between the respective read coordinates. For example, in a case where the CPU 210 detects that the coordinate values of an elbow joint are higher than the coordinate values of shoulder joints of the player 109a, and the coordinate values of a wrist joint are higher than the coordinate values of the elbow joint, it is determined that the player 109a is in a state of extending the arm in the upward direction. Here, a high “coordinate value” means that the coordinate value on the coordinate axis in the vertical direction is great.

Further, in a case where the coordinate value of the ball coordinates 602b is higher than the coordinate values of the wrist joint of the player 109a, the CPU 210 determines that the player 109a is taking a shot. These determination processes are performed for the number of players 109 whose joint coordinates 603 have been detected, and the joint coordinates 603 such that the ball coordinates 602b is the closest to the coordinate values of the wrist joint of the player 109 are selected. In this manner, the CPU 210 can determine whether a shot is being made.

It should be noted that, in the present embodiment, determination whether a player has taken a shot is made by comparing the ball coordinates with the joint coordinates of the player, but the determination method is not limited to this. For example, a “decision tree model” to which an image of the player 109a in action, such as the target region image signal 601, is input, and which outputs a result of determination as to whether a shot has been taken is prepared, and determination whether a shot has been taken may be made, using a result of determination made by the decision tree model. Further, in the present embodiment, the type of action to be determined is set to “taking a shot” for the purpose of picking up a scene of a shot being made by a player, and the action is not limited to any particular type. For example, the present disclosure can be applied to determination as to any action that can be identified from a player's posture, such as “passing” or “dribbling”. If it is determined that the player 109a is taking a shot (YES), the CPU 210 makes the process proceed to step S407. On the other hand, if it is determined that the player 109a is not taking a shot (NO), the CPU 210 makes the process proceed to step S408.

Next, based on the result of the processing in step S406, the CPU 210 reads the software for the processing/computing part 804 from the ROM 212, loads the software into the RAM 211, and carries out step S407. Specifically, in step S407, the CPU 210 calculates a control value for the pan-tilt drive unit 226 of the targeting camera 104 for setting the image pickup direction of the targeting camera 104 toward the shot scene. Here, the “control value” is a combination of the “control direction” and the “control speed” in the present embodiment. For example, the control value for the pan drive is expressed as “a speed of 10 (degrees/second) in the rightward direction” or the like, and the pan control speed is determined based on the difference between the current position and the target position for the panning. It should be noted that the target position for the panning may be directly designated as the control value. In this manner, in step S407, the CPU 210 generates a camera control signal used for directing the targeting camera 104 to the shot scene.

In a case where the image pickup direction and the position of the overview camera 102 greatly differ from the image pickup direction and the position of the targeting camera 104, the positions of the overview camera 102 and the targeting camera 104 may be calibrated in advance. In this case, the ball coordinates 602a viewed from the overview camera 102 and the joint coordinates 603 of the player can be transformed into the coordinate system of the targeting camera 104. Thus, the present disclosure can be applied even in a case where the image pickup direction and the position of the overview camera 102 greatly differ from the image pickup direction and the position of the targeting camera 104. It should be noted that an example of the position calibration method herein is a method by which a calibration pattern such as a grid pattern is simultaneously picked up by cameras located at two points, so that camera parameters including information about the relative positions and orientations of the cameras are calculated. Also, the corresponding points between the image pickup coordinates of the overview camera 102 and the image pickup coordinates of the targeting camera 104 can be calculated on the basis of the epipolar geometry using the calculated camera parameters.

Next, the CPU 210 performs the following calculation based on the ball coordinates 602a stored in the RAM 211 and the target region size of the target region image signal 601 (this size will be hereinafter referred to as the size of the target region). That is, the CPU 210 calculates the control value for the zoom drive unit 225 of the targeting camera 104, to keep the ball 110 and the players 109 located in the vicinity thereof within the angle of view θ.

Here, a specific process of calculating the control value for the lens drive is described. First, the maximum value and the minimum value of the focal length of the targeting camera 104 in image pickup are defined. Specifically, before the start of the process according to the present embodiment, a user measures the focal length T (maximum value) with which the ball 110 and the entire bodies of the players 109 fall within the angle of view θ in a case where the ball 110 is at the deepest position in the basketball court 108. Also, the user measures the focal length W (minimum value) with which the ball 110 and the entire bodies of the players 109 fall within the angle of view θ in a case where the ball 110 is at the frontmost position in the basketball court 108. Here, at the “deepest position” and the “frontmost position”, an image picked up by the targeting camera 104 can be approximated by the overview image signal 600 in a case where the installation position of the targeting camera 104 is close to the installation position of the overview camera 102 having the image pickup optical axis perpendicular to the sidelines of the basketball court 108. In this case, the upper sideline in the overview image signal 600 is at the “deepest position”, and the lower sideline in the overview image signal 600 is at the “frontmost position”. Further, in a case where the image pickup optical axis of the targeting camera 104 is set to be perpendicular to the endlines of the basketball court 108 as illustrated in FIG. 1, the endline on the left side when viewed from the front side of the overview camera 102 is at the “deepest position”, and the endline on the right side is at the “frontmost position”. It should be noted that, although the focal lengths T and W are set to focal lengths with which the ball 110 and the entire bodies of the players 109 fall within the angle of view θ, the focal lengths are not necessarily limited to these lengths, and may be set to any focal lengths by a user.

The measured focal lengths T and W are input to the client terminal 107, are then transmitted to the image processing apparatus 103, and are stored into the RAM 211. Next, the CPU 210 transforms the installation position, the deepest position, and the frontmost position of the targeting camera 104 into the coordinate system of the overview image signal 600, based on the result of position calibration. Next, the CPU 210 defines the distance from the targeting camera 104 to the deepest position in the overview image signal 600 as “LL1”, the distance from the targeting camera 104 to the frontmost position as “LL2”, and the distance from the targeting camera 104 to the ball coordinates 602a as “LL3”. The CPU 210 then calculates a target zoom position Z associated with the distance from the focal length T to the focal length W according to the following Expression 1.

$$Z = W + ( ( T - W ) \times \frac{( L L 3 - L L 2 )}{( L L 1 - L L 2 )} ) \qquad Expression 1$$

The lens drive control direction is determined based on the current zoom position and the target zoom position Z. For example, in a case where the current zoom position is “30 mm” and the target position is “100 mm”, the control direction is “TELE direction”. In a case where the zoom drive unit 225 works to pick up a large image of a subject, telephoto is referred to as the “tele direction”. Meanwhile, the lens drive control speed is determined based on the magnitude of the difference between the current zoom position and the target zoom position Z. For example, in a case where a difference DD between the current zoom position and the target zoom position is smaller than “10 mm”, the control speed is set to “0 mm/sec”. In a case where the difference DD is “10 mm or larger”, the control speed is set to “(DD×10) mm/sec”. Each of these numerical values is an example, and the contents of control are not limited to the these values. For example, an upper limit value may be set on the control speed.

It should be noted that, in the present embodiment, the control value for zooming is calculated based on the installation position of the targeting camera 104, but the calculation process is not limited to this. For example, a new path may be established to feed images picked up by the targeting camera 104 into the image processing unit 103, and object detection and posture estimation may be performed on an image picked up by the targeting camera 104 in the same manner as with the overview image signal 600. The positions of the players 109 and the ball 110 within the angle of view θ of image pickup by the targeting camera 104 can be then estimated, and zoom control may be performed so that the ball 110 and the entire body of the player 109 located in the vicinity thereof fall within the angle of view θ. Further, in the present embodiment, the control value for the zoom drive unit 225 is a control value necessary for keeping the ball 110 and the entire body of the player 109 located in the vicinity thereof within the angle of view θ. However, the control value for the zoom drive unit 225 is not limited to this. For example, in a case where a player is to be picked up in an image of a upper-body-focused composition, the control value may be calculated as described below. That is, the joint coordinates 603 of the player 109 may be transformed from the coordinate system in the target region image signal 601 into the coordinate system in the overview image signal 600, and may be set to a control value necessary for keeping the joint coordinates of the body portions above the waist joint of the player 109 within the angle of view θ.

Further, after execution of step S407, the CPU 210 stores, into the RAM 211, the respective control values (hereinafter referred to as the “camera control signals”) of the pan-tilt drive unit 226 and the zoom drive unit 225 as calculated in step S407, and makes the process proceed to step S409. On the basis of the result of the processing in step S406, the CPU 210 reads the software for the processing/computing part 804 from the ROM 212, loads the software into the RAM 211, and carries out step S408. Specifically, in step S408, the CPU 210 calculates the control value for the pan-tilt drive unit 226 of the targeting camera 104 to set the image pickup direction of the targeting camera 104 toward the ball coordinates 602a, based on the ball coordinates 602a stored into the RAM 211 in step S402. Also, the CPU 210 calculates the control value for the zoom drive unit 225 of the targeting camera 104 to keep the ball 110 and a “predetermined region” around the ball 110 within the angle of view θ, based on the ball coordinates 602a stored in the RAM 211.

Here, the “predetermined region” may be a region including all the players whose joint coordinates 603 in the target region image signal 601 have been detected. Alternatively, the “predetermined region” may be a region including only the player closest to the ball coordinates 602a. It should be noted that the process of calculating the control values of the pan-tilt drive unit 226 and the zoom drive unit 225 is the same as that in step S407.

It should be noted that, even in a case where it is determined in step S406 that the scene is not a shot scene, the image pickup direction of the targeting camera 104 is set toward the ball coordinates 602a in step S408, because a shot occurs from the position of the ball serving as the starting point. As a result, the amount of driving of the targeting camera 104 can be minimized when a scene of a shot occurs, and the time delay until the targeting camera 104 completely faces in the direction of the shot scene can be reduced. After that, the CPU 210 stores the camera control signals calculated in step S407 into the RAM 211, and makes the process proceed to step S409. That is, in both steps S407 and S408, the CPU 210 generates camera control signals for directing the targeting camera 104 in a direction corresponding to the result of recognition as to whether the player 109a has taken a shot based on the ball coordinates 602a and the joint coordinates 603 in step S406. As the camera control signals for directing the targeting camera 104 to the shot scene are generated in step S407, and the camera control signals for directing the targeting camera 104 to the ball coordinates is generated in step S408, camera control signals for setting the image pickup direction of the targeting camera 104 toward the target region are generated in either case.

Next, the CPU 210 reads the software for the communication part 803 from the ROM 212, loads the software into the RAM 211, and carries out step S409. Specifically, in step S409, the CPU 210 transmits the camera control signals stored into the RAM 211 in step S407, to the targeting camera 104 via the NIC 215.

FIG. 4C is a flowchart illustrating a process to be performed by the targeting camera 104, and is an explanatory diagram of a process to be performed by the image pickup part 807, the drive control part 808, and the communication part 809 in FIG. 3. In the following, a process to be performed by the targeting camera 104 is described with reference to FIG. 4C.

First, the CPU 218 reads the software for the communication part 809 from the ROM 220, loads the software into the RAM 219, and carries out step S500. Specifically, in step S500, the CPU 218 determines whether the “camera control signals” transmitted from the image processing apparatus 103 in step S409 has been received via the NIC 222. If it is determined that the camera control signals have been received (YES), the CPU 218 stores the received camera control signals into the RAM 219, and makes the process proceed to step S501. On the other hand, if it is determined that the camera control signals have not been received (NO), the CPU 218 waits for reception in step S500.

Next, the CPU 218 reads the software for the drive control part 808 from the ROM 220, loads the software into the RAM 219, and carries out step S501. Specifically, in step S501, the CPU 218 controls the pan-tilt drive unit 226 and the zoom drive unit 225 based on the camera control signals stored into the RAM 219 in step S500.

Next, the CPU 218 reads the software for the image pickup part 807 from the ROM 220, loads the software into the RAM 219, and carries out step S502. Specifically, in step S502, the CPU 218 controls the video engine 221 and the image sensor 224, and generates image pickup data with the angle of view θ including the player 109 and the ball 110 present in the image pickup direction. That is, in step S502, the image pickup part 807 picks up the target region including a shot scene being taken by the player 109 present in the image pickup direction, and the position of the ball present in the image pickup direction.

Next, a process of generating the target region image signal 601, which is a process characteristic of the present system, is described with reference to FIGS. 6 and 7. It should be noted that FIG. 7 is an explanatory diagram schematically illustrating the contents to be described with reference to FIG. 6. FIG. 6 is a flowchart illustrating detailed processing in step S403 (a subroutine) in the flowchart illustrating a process to be performed by the image processing apparatus 103. In the following, a process to be performed by the image processing apparatus 103 is described with reference to FIG. 6.

First, in step S700, the CPU 210 performs computations based on a Hough transform process, on the overview image signal 600 stored in the RAM 211. Here, the quadrangle formed with the resultant straight lines is regarded as the court lines of the basketball court 108. It should be noted that, in a case where there is a court line having a color different from that of the court lines of the basketball court 108 in the overview image signal 600, the computations can be performed after the color of the court lines of the basketball court 108 is designated. Further, in a case where the color of the floor is different between the inside and the outside of the basketball court 108, the boundary lines in the floor color may be used as the court lines. The CPU 210 stores the determined court lines of the basketball court 108 into the RAM 211, and makes the process proceed to step S701. It should be noted that the court line calculation process is not limited to this, and, for example, the court lines may be determined by performing an edge extraction process with an SOBEL filter, a CANNY method, or the like on the overview image signal 600, to calculate the boundaries of the quadrangle. In this manner, in step S700, the CPU 210 performs Hough transform on the overview image signal 600, to extract the court lines of the basketball court 108.

Next, in step S701, the CPU 210 obtains a quadrangle that is formed based on the court lines of the basketball court 108 stored into the RAM 211 in step S700, and calculates the coordinate values of the four vertexes of the quadrangle (these coordinate values will be hereinafter referred to as the “court coordinates”). Here, as illustrated in FIG. 7, the four vertexes of the quadrangle are the upper left vertex “A”, the lower left vertex “B”, the lower right vertex “C”, and the upper right vertex “D”. That is, the quadrangle formed based on the court lines is a quadrangle ABCD. The CPU 210 stores the calculated court coordinates into the RAM 211, and makes the process proceed to step S702.

Next, in step S702, the CPU 210 calculates an “upper base L1” formed with a line segment AD of the quadrangle ABCD and a “lower base L2” formed with a line segment BC, based on the court coordinates stored into the RAM 211 in step S701 (see FIG. 7). After that, the CPU 210 stores the positions and the lengths of the calculated upper base L1 and lower base L2 into the RAM 211, and makes the process proceed to step S703.

Next, in step S703, based on the ball coordinates 602 stored in the RAM 211 and the positions of the upper base L1 and the lower base L2 stored into the RAM 211 in step S701, the CPU 210 calculates the straight line that is parallel to the upper base L1 and the lower base L2 and passes through the ball coordinates 602. It should be noted that a case where the upper base L1 and the lower base L2 in the overview image signal 600 are not parallel will be described in the third embodiment. Next, the CPU 210 calculates, as a “line segment L3”, a line segment PQ in which the point of intersection with the line segment AB is “P”, and the point of intersection with the line segment CD is “Q”, among the above-mentioned straight lines (see FIG. 7). The CPU 210 stores the length of the calculated line segment L3 into the RAM 211, and makes the process proceed to step S704.

Next, in step S704, based on the length of the lower base L2 stored into the RAM 211 in step S702 and the length of the line segment L3 stored into the RAM 211 in step S703, the CPU 210 calculates the “target region size”, which is the image size of the target region image signal 601, from the ratio between the lengths of the respective line segments. Specifically, before the start of the process according to the present embodiment, a user picks up an image of the overview image signal 600 when a player 109 is present on the lower sideline in FIG. 1, and measures the size of the entire body of the player 109 in the image. After that, the CPU 210 stores, into the RAM 211, the size of the entire body that has been input by a user via the client terminal 107, and generates a “reference target region size” based on the size of the entire body. Here, the “reference target region size” is the length of one side of the quadrangle forming the “target region”, the vertical length is twice the height of the player 109 in the overview image signal 600, and the ratio between the horizontal length and the vertical length is “1:1”. It should be noted that the “reference target region size” is not limited to this, and may be any size that allows the player taking a shot to be cropped without being cut off.

The CPU 210 then stores the generated “reference target region size” into the RAM 211. The CPU 210 calculates the target region size based on the reference target region size stored in the RAM 211 and the ratio between the lower base L2 and the line segment L3. Where the reference target region size is defined as “SB”, the length of the lower base L2 is defined as “L2”, and the length of the line segment L3 is defined as “L3”, the target region size S is calculated according to the following Expression 2.

$$S = SB \times \frac{L 3}{L 2} \qquad Expression 2$$

After that, the CPU 210 stores the target region size into the RAM 211, and makes the process proceed to step S705. By the above process, the target region size becomes smaller as the distance from the overview camera 102 to the ball 110 becomes longer. Conversely, the target region size becomes larger as the distance from the overview camera 102 to the ball 110 becomes shorter.

Next, in step S705, the CPU 210 calculates “target region coordinates 701 (see FIG. 7)” based on the ball coordinates 602 stored in the RAM 211 and the target region size stored into the RAM 211 in step S704. Here, the “target region coordinates 701” are the coordinates of the upper left vertex and the lower right vertex of a region in which one side of the rectangle is of the target region size with the ball coordinates 602 as the center (or a rectangular region obtained by enlarging the rectangular region in four directions by a preset enlargement value). The CPU 210 stores the calculated target region coordinates 701 into the RAM 211, and makes the process proceed to step S706.

Next, in step S706, the CPU 210 crops the “target region” from the overview image signal 600 based on the target region coordinates 701 stored into the RAM 211 in step S705, and generates the target region image signal 601. After that, the CPU 210 stores the generated target region image signal 601 into the RAM 211. The above is a description of the processing in step S403 in the process to be performed by the image processing apparatus 103. The subsequent process continues to step S404 (see FIG. 4B) to be performed by the image processing apparatus 103.

The above is a description of a process to be performed according to the first embodiment by the configuration illustrated in FIG. 1. As described above, a player (the second object) in a picked-up image can be cropped with a size based on the position of the ball (the third object) in the basketball court 108 (the first object). Thus, it is possible to lower the possibility that predetermined recognition cannot be made because a player is cut off due to a small cropping size with respect to the size of the player, or the subject is crushed by the reduction before the recognition due to a large cropping size. It should be noted that the application range of the present disclosure is not limited to the above, and the present disclosure can be applied to various scenes in other sports different from basketball, music live shows, lectures in auditoriums, and the like. For example, it is suitable for sports such as soccer and tennis, in which players' actions near a ball, such as shooting, serving, and smashing, are recognized.

It should be noted that, although an example in which automatic image pickup is performed from image pickup data of one overview camera 102 has been described in the first embodiment, the present disclosure is not limited to this. The present disclosure can also be applied to a system using a plurality of overview cameras. In this case, position calibration is performed for the overview cameras, and the respective pieces of image pickup data are integrated based on the result of the calibration, to generate one set of image pickup data. After that, the present disclosure can be applied to the integrated image pickup data. Accordingly, the present disclosure can be easily applied to sports and places involving a wide playing field, such as soccer and rugby.

Further, in a case where the present disclosure is applied to a scene where a subject performs a predetermined action such as singing or pointing to a blackboard, as in a music live show or a lecture in an auditorium, it is sometimes difficult to detect the court coordinates from the overview image signal 600. In this case, the court lines can be calculated by setting the target straight lines so as to surround the stage, and thus, the present disclosure is applicable. Also, instead of the court lines, marks of a specific color and a specific shape may be attached to positions that serve as the respective vertexes of a quadrangular stage in the real world, and the marks may be calculated from image pickup data of the overview camera 102, to calculate the quadrangle ABCD that forms the stage. That is, the CPU 210 may be designed to detect the marks provided at the respective positions corresponding to the respective vertexes of the object of the basketball court 108 in the real world, and acquire the region having the respective marks as the vertexes as the object shape of the basketball court 108.

Further, in the first embodiment, in step S402 of the processing flow to be executed by the image processing apparatus 103, the CPU 210 detects the position coordinates of the ball 110, using an object detection model. However, the ball detection process is not limited to this. For example, a position sensor may be attached to the ball 110, and the position sensor receiving device 115 that receives a signal of the position sensor may be provided in the system configuration in FIG. 1. The coordinate system of the position sensor receiving device 115 and the coordinate system in an overview image signal 600 to be picked up by the overview camera 102 should be subjected to position calibration in advance. The position sensor receiving device 115 receives the position of the position sensor attached to the ball 110. The position sensor receiving device 115 transmits the position obtained from the position sensor to the image processing apparatus 103. The image processing apparatus 103 transforms the position of the position sensor received from the position sensor receiving device 115 into the coordinate system in the overview image signal 600, and uses the transformed position of the position sensor as the ball coordinates 602. In this manner, a sensor that detects the position of the ball 110 may be used. As described above, the CPU 210 may acquire the position information about the sensor that is attached to the ball 110 and detects the position of the ball 110, which is a real-world object corresponding to a ball object (the third object), and calculate the target position on the basis of the position information acquired by the sensor.

Also, in the present embodiment, the position coordinates of the ball 110 are detected as a target position from the overview image signal 600, on the assumption that a highlight scene occurs in the vicinity of the ball 110. However, the present disclosure is not limited to this. For example, the position coordinates of a specific player 109, instead of the ball 110, may be detected as a target position. In this case, before the start of the process according to the present embodiment, an object detection model that inputs image data including a player 109 and performs inference using “rectangular coordinates” circumscribing the player 109 in the image data as an output may be used. Specifically, first, in step S402 in FIG. 4B, the CPU 210 of the image processing apparatus 103 controls the GPU 213, to detect the position coordinates of the player 109 from the reduced image signal 604, using a trained model. Next, in step S403 in FIG. 4B, the CPU 210 of the image processing apparatus 103 can also perform a process according to the present disclosure, by generating the target region image signal 601 from the overview image signal 600 on the basis of the detected position coordinates of the player 109. Thus, highlight scenes of only the target player can be effectively obtained.

Also, in the present embodiment, in step S700 to be performed by the image processing apparatus 103, the CPU 210 calculates the court lines of the basketball court 108, using Hough transform. However, the method of calculating the court lines is not limited to this. The present disclosure can be applied to any calculation mode capable of calculating court lines. For example, a user interface (UI) that allows a user to designate the vertexes of the basketball court 108 may be used. Specifically, before the start of a process according to the present embodiment, the CPU 243 of the client terminal 107 operates the overview camera 102 via the NIC 248 of the client terminal 107, to receive the overview image signal 600. Next, the CPU 243 displays the received overview image signal 600 on the display unit 249 of the client terminal 107. Next, the CPU 243 receives an operation of the input unit 250 of the client terminal. A user operating the client terminal 107 designates the four vertexes of the basketball court 108 in the displayed overview image signal 600. The CPU 243 then transmits the four sets of coordinates in overview image signal 600 designated via the NIC 248, to the image processing apparatus 103.

Next, the CPU 210 defines the quadrangle formed with the four sets of coordinates in the overview image signal 600 received from the client terminal 107 as the court lines, so that the present disclosure can be applied thereto. Thus, it is possible to obtain an effect that the present disclosure can be applied even in a case where the court lines cannot be calculated from the overview image signal 600. Further, for example, a distorted shape in the overview image signal 600 may be estimated from the known shape of the basketball court 108, to detect the court lines. Specifically, first, the CPU 210 of the image processing apparatus 103 estimates the distorted shape of the basketball court 108, based on the image pickup angle of the overview camera 102 with respect to the basketball court 108. The CPU 210 of the image processing apparatus 103 acquires a distorted quadrangle (which is the trapezoidal basketball court 108 illustrated in FIG. 7) through the result of the estimation.

Next, the CPU 210 of the image processing apparatus 103 detects the position and the shape of an object with which the calculation result obtained by performing an edge calculation process on the overview image signal 600 and the distorted quadrangle have similitude relations. The CPU 210 of the image processing apparatus 103 can then apply the present disclosure thereto in the same manner, by acquiring the court lines based on the detected position and shape of the object. In this manner, even in a case where the court lines cannot be calculated from the overview image signal 600, it is possible to apply the present disclosure by calculating the court lines of the basketball court 108. Further, as described above, the “distortion information” is generated by the CPU 210 estimating a distorted shape, performing predetermined detection, and the like.

Next, a second embodiment of the present disclosure is described. In the second embodiment, a process of obtaining the shape of the basketball court 108 by using camera information acquired from the overview camera 102 and generating the target region image signal 601 is described. As the basic configuration of the image processing system is the same as that of the first embodiment, repetitive explanation is avoided, and different processing to be performed by the image processing apparatus 103 is described. Also, in the second embodiment, it is assumed that the image pickup optical axis 114 of the overview camera 102 and the half-court line of the basketball court 108 are parallel to each other as illustrated in FIG. 1, and the overview camera 102 is installed so that the closer sideline of the basketball court 108 falls within the angle of view θ. That is, the horizontal length of the overview image signal 600 is the same as or substantially equal to the length of the closer sideline of the basketball court 108 in the overview image signal 600.

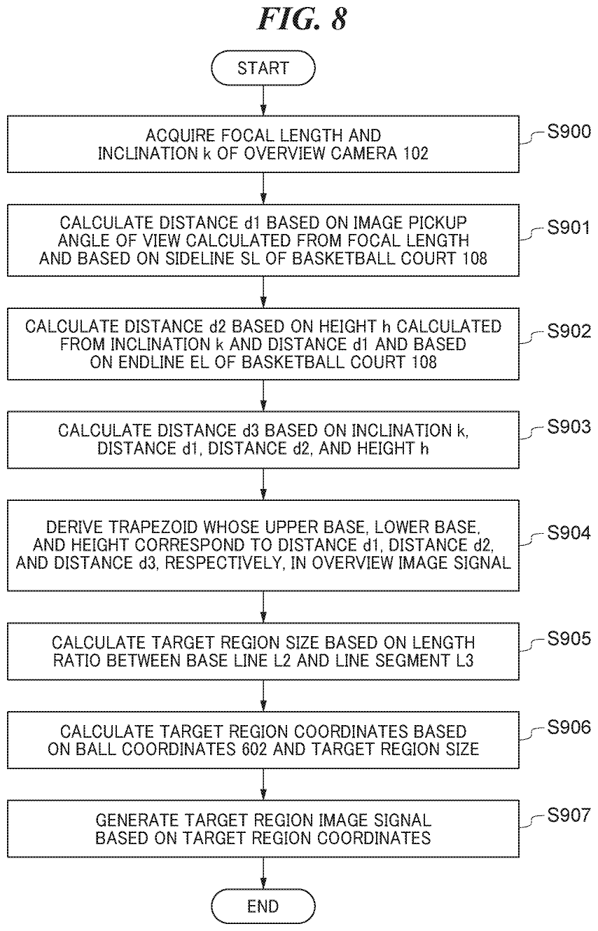

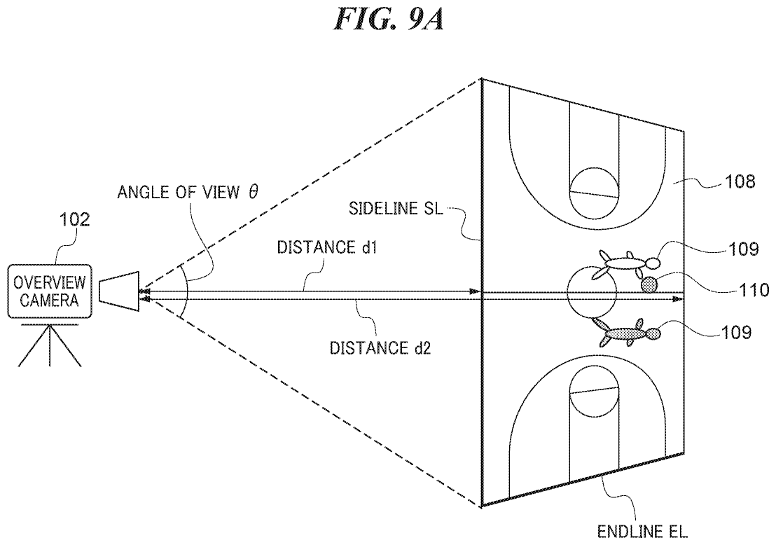

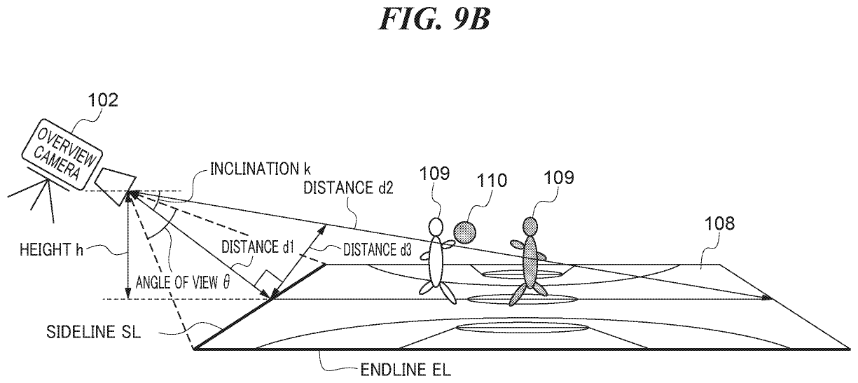

FIG. 8 is a chart illustrating a process of generating the target region image signal 601, which is a process characteristic of the image processing apparatus 103 according to the second embodiment. FIGS. 9A and 9B are explanatory diagrams of the generation process illustrated in FIG. 8. The process from when the CPU 210 receives the overview image signal 600 from the overview camera 102 and reduces the overview image signal 600 to when the position of the ball is detected from the reduced image signal 604 is the same as the process up to step S402 in the first embodiment (see FIG. 4B). The following description concerns the contents of the process according to the second embodiment in step S403.

First, in step S900, the CPU 210 of the image processing apparatus 103 requests the CPU 201 of the overview camera 102 to transmit information indicating the focal length of the lens (not illustrated) of the overview camera 102 and the inclination of the overview camera 102 via the NIC 215. In response to this, the CPU 201 acquires the focal length and an “inclination k” of the overview camera 102 from the zoom drive unit 208 and the inclination sensor 227. The CPU 201 then transmits the focal length and the “inclination k” acquired via the NIC 205 to the image processing apparatus 103. In response to this, the CPU 210 acquires the focal length and the “inclination k” received from the overview camera 102, stores the focal length and the “inclination k” into the RAM 211, and makes the process proceed to step S901.

Next, in step S901, the CPU 210 calculates the angle of view θ of the overview camera 102 from the focal length stored into the RAM 211 in step S900. The CPU 210 then calculates a “distance d1” from the overview camera 102 to the closer sideline, based on the angle of view θ and the length (SL) of the closer sideline of the basketball court 108 in the real world. Specifically, in step S901, where the length of the closer sideline of the basketball court 108 in the real world is defined as “SL”, the “distance d1” from the overview camera 102 to the sideline SL is calculated according to the following Expression 3.

$$d 1 = \frac{S L}{2 \times TAN ( \frac{θ}{2} )} \qquad Expression 3$$

The CPU 210 stores the calculated “distance d1” into the RAM 211, and makes the process proceed to step S902. In step S902, the CPU 210 calculates a height h from the plane in which the basketball court 108 is present in the real-world to the overview camera 102, based on the “distance d1” stored in the RAM 211 and the “inclination k” stored into the RAM 211 in step S900. Specifically, where the inclination of the overview camera 102 with respect to the horizontal direction is defined as “k”, and the distance from the overview camera 102 to the sideline SL is defined as “d1”, the CPU 210 calculates the “height h” of the overview camera 102 according to the following Expression 4.

h=cos(90−k)×d1 Expression 4

The CPU 210 stores the calculated “height h” into the RAM 211. The CPU 210 calculates a “distance d2” from the overview camera 102 to the farther sideline, based on the “height h” stored in the RAM 211, the “distance d1” stored into the RAM 211 in step S901, and the length “EL” of the endlines of the basketball court 108 in the real world. Specifically, first, the CPU 210 defines the distance from the overview camera 102 to the closer sideline SL as “d1”, the height of the overview camera 102 as “h”, and the length of the endlines of the basketball court 108 in the real world as “EL”. The CPU 210 then calculates the “distance d2” from the overview camera 102 to the farther sideline according to the following Expression 5. The CPU 210 stores the calculated “distance d2” into the RAM 211, and makes the process proceed to step S903.

$$d 2 = \sqrt{( {( \sqrt{d {1}^{2} - {h}^{2} )} + EL )}^{2} + {h}^{2} )} \qquad Expression 5$$

Next, in step S903, the CPU 210 calculates a “distance d3” described below, based on the “inclination k” and the “height h” of the overview camera 102, the “distance d1”, and the “distance d2” stored in the RAM 211. That is, the “distance d3” of a straight line that is perpendicular to the straight line of the “distance d1” and connects the closer sideline SL of the basketball court 108 in the real world to the point of intersection with the straight line of the “distance d2” is calculated. Specifically, the CPU 210 defines the inclination of the overview camera 102 with respect to the horizontal direction as “k”, the height of the overview camera 102 as “h”, and the distance from the overview camera 102 to the closer sideline SL as “d1”. Further, where the distance from the overview camera 102 to the farther sideline is defined as “d2”, the CPU 210 calculates the “distance d3” from the sideline SL to the “distance d2” according to the following Expression 6. After that, the CPU 210 stores the calculated “distance d3” into the RAM 211, and makes the process proceed to step S904.

$$d 3 = TAN ( k - ( 90 - {COS}^{- 1} ( \frac{h}{d 2} ) ) ) \times d 1 \qquad Expression 6$$

Next, in step S904, based on the “distance d1”, the “distance d2”, and the “distance d3” stored in the RAM 211, the CPU 210 identifies the trapezoid whose upper base, lower base, and height correspond to the “distance d1”, the “distance d2”, and the “distance d3”, respectively. Specifically, the distance from the overview camera 102 to the closer sideline SL is defined as “d1”, and the distance from the overview camera 102 to the farther sideline is defined as “d2”. At this point of time, the upper base and the lower base of the trapezoid calculated from the overview image signal 600 satisfy the following Relational Expression 7.

d1:d2=Upper Base:Lower Base Relational Expression 7

Subsequently, the distance from the sideline SL to the line segment of the “distance d2” is defined as “d3”. At this point of time, the height of the trapezoid calculated from the overview image signal 600 satisfies the following Relational Expression 8.

SL:d3=Lower Base L2:Height Relational Expression 8

Based on the identified trapezoid, the CPU 210 then calculates the respective vertex coordinates (hereinafter referred to as the “trapezoid coordinates”) of the identified trapezoid in the overview image signal 600. The CPU 210 stores the calculated trapezoid coordinates into the RAM 211. The CPU 210 calculates the line segment L3 based on the ball coordinates 602 stored in the RAM 211 and the positions of the upper base and the lower base of the trapezoid calculated from the trapezoid coordinates, according to the processing in step S703 in FIG. 6 described in the first embodiment. The CPU 210 stores the calculated length of the line segment L3 into the RAM 211, and makes the process proceed to step S905. As illustrated in FIG. 7, the line segment L3 is the line segment PQ that is parallel to the upper base and the lower base of the identified trapezoid, and extends through the coordinates of the ball.

Next, in step S905, the CPU 210 performs the same processing as that in step S704 of the first embodiment, to calculate the “target region size”. That is, the CPU 210 calculates the target region size, on the basis of the ratio between the length of the lower base L2 and the length of the line segment L3. Here, the lower base L2 is the one illustrated in FIG. 7. The CPU 210 stores the calculated target region size into the RAM 211, and makes the process proceed to step S906.

Next, in step S906, the CPU 210 performs the same processing as that in step S705 of the first embodiment, to calculate the target region coordinates 701. That is, the CPU 210 calculates the target region coordinates 701 based on the ball coordinates 602 and the target region size. The CPU 210 stores the calculated target region coordinates 701 into the RAM 211, and makes the process proceed to step S907.

Next, in step S907, the CPU 210 performs the same processing as that in step S706 of the first embodiment, to generate the target region image signal 601. That is, the CPU 210 calculates the target region image signal 601 based on the target region coordinates 701. The CPU 210 then stores the generated target region image signal 601 into the RAM 211. The above is a description of the process of generating the target region image signal 601, which is a process characteristic of the image processing apparatus 103 in the second embodiment. The process to be performed thereafter follows step S404 in the process to be performed by the image processing apparatus 103 of the first embodiment (see FIG. 4B).

The above is a description of a process to be performed according to the second embodiment of the present disclosure in the configuration of the image processing system illustrated in FIG. 1. As described above, the object shape of the basketball court 108 can be calculated based on camera information acquired from the overview camera 102. Thus, even in a case where the object shape of the basketball court 108 cannot be detected from the overview image signal 600 by a process performed by the image processing apparatus 103, the present disclosure can be applied, without requiring users to perform any additional operation.

Next, a third embodiment of the present disclosure is described. In the third embodiment, a process of generating the target region image signal 601 in a case where the image pickup optical axis 114 of the overview camera 102 is not parallel to the half-court line of the basketball court 108 is described. As the basic system configuration is the same as that of the first embodiment, repetitive explanation is avoided, and the process to be performed by the image processing apparatus 103, which is the different aspect, is described.

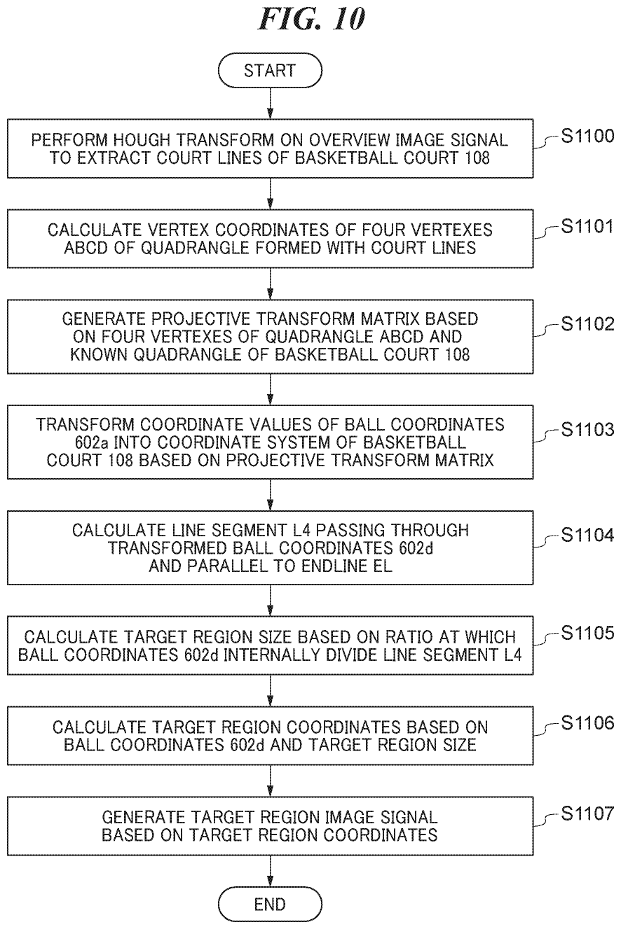

FIG. 10 is a chart illustrating a process of generating the target region image signal 601, which is a process characteristic of the image processing apparatus 103 according to the third embodiment. FIGS. 11A and 11B are explanatory diagrams of the process illustrated in FIG. 10. The process from when the overview image signal 600 is received from the overview camera 102 and is reduced to when the position of the ball is detected from the reduced image signal 604 is the same as the process to be performed by the image processing apparatus 103 of the first embodiment (see FIG. 4B). That is, the process up to step S402 is the same as that of the first embodiment. The following description concerns the contents of the process in step S403 in the third embodiment.

First, in step S1100, the CPU 210 performs the same processing as that in step S700 of the first embodiment, and performs computing based on a Hough transform process on the overview image signal 600. Here, the quadrangle formed with the straight lines obtained as a result of the computing is regarded as the court lines of the basketball court 108. The CPU 210 stores the court lines of the basketball court 108 obtained by the computing into the RAM 211, and makes the process proceed to step S1101.

Next, in step S1101, the CPU 210 performs the same processing as that in step S701 of the first embodiment, to calculate the court coordinates. That is, the CPU 210 calculates the vertex coordinates of the four vertexes A, B, C, and D of the quadrangle formed with the court lines. FIG. 11 illustrating the four vertexes A, B, C, and D. It should be noted that, in the third embodiment, the image pickup optical axis 114 of the overview camera 102 is not parallel to the half-court line of the basketball court 108, and therefore, the quadrangle of the basketball court 108 that appears in the overview image signal 600 has a distorted shape (see FIG. 11A). Further, in conjunction with this, the calculated court coordinates differ from the court coordinates of the first embodiment, and are the respective vertex coordinates of the distorted quadrangle. The CPU 210 stores the calculated court coordinates into the RAM 211, and makes the process proceed to step S1102.

Next, in step S1102, the CPU 210 performs projective transform between the coordinate system of the overview image signal 600 and the basketball court coordinate system defined based on the known shape of the basketball court 108. Specifically, the CPU 210 generates a “projective transform matrix” between the court coordinates on the coordinate system of the overview image signal 600 stored into the RAM 211 in step S1101 and the vertex coordinates of the four vertexes of the basketball court on the basketball court coordinate system. The CPU 210 stores the calculated projective transform matrix into the RAM 211, and makes the process proceed to step S1103.

Next, in step S1103, based on the projective transform matrix stored into the RAM 211 in step S1102, the CPU 210 performs projective transform on the ball coordinates 602a from the coordinate system in the overview image signal 600 to the basketball court coordinate system. As a result, as illustrated in FIG. 11B, the ball coordinates are as indicated by 602d. The CPU 210 stores the ball coordinates 602d of the basketball court coordinate system into the RAM 211, and makes the process proceed to step S1104.

Next, in step S1104, based on the ball coordinates 602d stored into the RAM 211 in step S1103, the CPU 210 calculates the straight line that is parallel to the endlines of the basketball court 108 and passes through the ball coordinates 602d. On the calculated straight line, the CPU 210 calculates a line segment RT as a “line segment L4”, where the point of intersection with the line segment AD of the quadrangle ABCD formed with the basketball court coordinate system is defined as “R”, and the point of intersection with the line segment BC is defined as “T”. The CPU 210 stores the length of the calculated “line segment L4” into the RAM 211, and makes the process proceed to step S1105.

Next, in step S1105, based on the length of the line segment L4 stored into the RAM 211 in step S1104, the CPU 210 calculates the “target region size”, which is the image size of the target region image signal 601, from the ratio at which the ball coordinates 602d internally divides the length of the line segment L4. Specifically, the sizes of the entire bodies of the players 109 in the overview image signal 600 when the players 109 are located on the closer and farther sidelines of the basketball court 108 are stored before the start of the process according to the present embodiment. A “closer reference target region size” and a “farther reference target region size” are then generated on the basis of the image size mentioned above.

Here, a “reference target region size” in the vertical direction is twice the size of the player 109 in the overview image signal 600, and the size in the horizontal direction is equal to the size in the vertical direction at a ratio of “1:1”. It should be noted that a “reference target region size” may be any size, as long as cropping can be performed without the player making a shot being cut off. The CPU 210 stores the generated closer and farther “reference target region sizes” into the RAM 211. The CPU 210 calculates a line segment from the intersection point R to the ball coordinates 602d on the line segment L4 as a “line segment L5”. The CPU 210 stores the length of the calculated “line segment L5” into the RAM 211.

The CPU 210 then scales the reference target region sizes in accordance with the ratio of the length of the line segment L5 to the length of the line segment L4, to generate a new target region size. Specifically, where the closer reference target region size is defined as “SF”, the farther reference target region size is defined as “SB”, the length of the line segment L4 is defined as “L4”, and the length of the line segment L5 is defined as “L5”, the CPU 210 calculates a new “target region size S” according to the following Expression 9. The CPU 210 stores the length of the new target region size into the RAM 211, and makes the process proceed to step S1106.

$$S = S B + ( ( S F - S B ) \times \frac{L 5}{L 4} ) \qquad Expression 9$$

Next, in step S1106, the CPU 210 calculates the “target region coordinates 701” based on the ball coordinates 602d stored into the RAM 211 according to the processing in step S705 of the first embodiment, and the target region size stored into the RAM 211 in step S1105. The CPU 210 stores the calculated target region coordinates 701 into the RAM 211, and makes the process proceed to step S1107.

Next, in step S1107, the CPU 210 crops the “target region” from the overview image signal 600 based on the target region coordinates 701 stored into the RAM 211 in step S1106 according to the processing in step S706 of the first embodiment, and generates the target region image signal 601. The CPU 210 stores the generated target region image signal 601 into the RAM 211.

The above is a description of the process of generating the target region image signal 601, which is a process characteristic of the image processing apparatus 103 in the present embodiment. As described above, the CPU 210 can generate distortion information based on the projective transform matrix between the coordinates indicating the vertexes of the first object (the basketball court 108) and the coordinates indicating the vertexes of the known shape of the first object. The CPU 210 can then determine the “target region” based on the distortion information and the calculated ball coordinates 602 (the target position), and determine the “target region size”, which is the size of the “target region”. An image that matches the “target region size” is an “target region image”.

The process to be performed thereafter follows step S404 in the processing flow to be executed by the image processing apparatus 103 of the first embodiment (see FIG. 4B). The above is a description of a process to be performed according to the third embodiment of the present disclosure in the configuration illustrated in FIG. 1. As described above, the court coordinates in the coordinate system in the overview image signal 600 can be projectively transformed into the basketball court coordinate system, which is a known shape. Thus, the present disclosure can be applied even in a case where the image pickup optical axis 114 of the overview camera 102 is not parallel to the half-court line of the basketball court 108.

Further, the CPU 210 (or the CPU 243) may include a user interface (a UI unit) that acquires an object shape received through a user operation as the shape of an object (the basketball court 108). Alternatively, the CPU 210 may acquire optical information such as the optical axis direction and the focal length of the lens of the overview camera 102 that picks up an overview image, and generate distortion information on the basis of the acquired optical information. Further, the HDD 216 or the like may store shape information regarding an object group including objects of a plurality of types of shapes. In this case, the CPU 210 may perform the following process. That is, in a case where there is a correlation between any piece of the plurality of types of shape information stored in the HDD 216 or the like and the object in an image picked up by the overview camera 102, the CPU 210 acquires the object corresponding to the shape information as the object of the basketball court 108.

According to the present disclosure, it is possible to provide image processing apparatuses, image processing systems, control methods, and storage media that enable highly accurate recognition of a predetermined action performed by an object in a picked-up image, regardless of the position of the object in the image-pickup angle of view.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image processing apparatus for recognizing a predetermined scene in a picked-up image, the image processing apparatus comprising:
one or more processors; and
at least one memory coupled to the one or more processors and storing instructions that, when executed by the one or more processors, cause the one or more processors to perform operations comprising:
receiving a picked-up image obtained by picking up an image of a first object;
generating distortion information indicating distortion, relative to a known shape, in a shape of the first object in the received picked-up image;
calculating a target position in the picked-up image;
determining a target region based on the generated distortion information and the calculated target position;
based on the determined target region, generating a target region image from the picked-up image;
scaling the generated target region image to a predetermined size; and
performing predetermined recognition based on the scaled target region image, wherein
in determining the target region, a target region size that is a size of the target region corresponding to an actual size, is determined based on the generated distortion information and the calculated target position.

2. The image processing apparatus according to claim 1, wherein
the distortion information is generated based on one or more of a degree of distortion in an object shape relative to a known shape, a size, and a shape among pieces of information regarding the first object in the picked-up image.

3. The image processing apparatus according to claim 1, wherein
the operations further comprise acquiring the shape of the first object in the picked-up image, and
the distortion information is generated based on the acquired shape of the first object.

4. The information processing device according to claim 3, further comprising a user interface that acquires, as the shape of the first object, an object shape received through a user operation.

5. The image processing apparatus according to claim 3, further comprising a storage unit that stores shape information for each object in an object group including objects of a plurality of shape types, wherein,
acquiring the shape of the first object comprises, in a case where a piece of a plurality of types of the shape information stored in the storage unit correlates with an object in the picked-up image, acquiring, for the shape of the first object, the object related to the piece of the shape information.

6. The image processing apparatus according to claim 3, wherein
acquiring the shape of the first object comprises detecting marks provided at points in real world, the points corresponding to vertexes of the first object, and acquiring, for the shape of the first object, a region with the marks as vertexes.

7. The image processing apparatus according to claim 3, wherein
the distortion information is generated based on a projective transform matrix between coordinates indicating vertexes of the acquired first object and coordinates indicating vertexes of the known shape of the first object.

8. The image processing apparatus according to claim 1, wherein
position information about a second object whose position has been estimated in the picked-up image is used for determining the target region.

9. The image processing apparatus according to claim 1, wherein
the operations further comprise acquiring position information from a sensor attached to a real-world object corresponding to a third object and configured to perform position detection, and
the target position is calculated based on the position information acquired from the sensor.

10. The image processing apparatus according to claim 1, wherein
the predetermined recognition comprises making a determination whether a second object in the target region image has performed a predetermined action.

11. The image processing apparatus according to claim 10, wherein
the determination whether the second object has performed the predetermined action is made based on a position of a third object and a position of the second object.

12. The image processing apparatus according to claim 11, further comprising a first trained model that estimates the position of the second object from the target region image, wherein
the position of the second object is estimated from the target region image, using the first trained model.

13. The image processing apparatus according to claim 11, further comprising a second trained model that detects the position of the third object from the target region image, wherein
the position of the third object is detected from the target region image that has been reduced, using the second trained model.

14. The image processing apparatus according to claim 11, wherein
the position of the second object is a position of a joint of a player who is playing a match in a real-world field corresponding to the first object, and
the position of the third object is a position of an object that is used in the match.

15. The image processing apparatus according to claim 1, wherein
the operations further comprise acquiring optical information including an optical axis direction and a focal length of a lens of a camera that picks up the picked-up image, and
the distortion information is generated based on the acquired optical information.

16. An image processing system comprising:
a first camera configured to pick up a picked-up image of a first object;
a second camera configured to perform image pickup in a designated image pickup direction; and
an image processing apparatus that controls the image pickup direction of the second camera, wherein
the first camera includes:
a first image pickup unit that acquires a picked-up image of the first object; and
a transmitter that transmits the picked-up image acquired by the first image pickup unit to the image processing apparatus,
the image processing apparatus includes:
one or more processors; and
at least one memory coupled to the one or more processors and storing instructions that, when executed by the one or more processors, cause the one or more processors to perform operations comprising:
receiving the picked-up image transmitted by the transmitter of the first camera;
generating distortion information indicating distortion, relative to a known shape, in a shape of the first object in the received picked-up image;
calculating a target position in the picked-up image;
determining a target region based on the generated distortion information and the calculated target position;
based on the determined target region, generating a target region image from the picked-up image;
scaling the generated target region image to a predetermined size;
performing predetermined recognition based on the scaled target region image;
generating a control signal for directing the second camera in an image pickup direction corresponding to a result of performing the predetermined recognition; and
transmitting the generated control signal to the second camera,
in determining the target region a target region size that is a size of the target region corresponding to an actual size, is determined based on the generated distortion information and the calculated target position, and
the second camera includes:
a second image pickup unit that performs image pickup;
a receiver that receives the control signal transmitted from the image processing apparatus; and
a controller that controls an image pickup direction of the second image pickup unit based on the control signal received by the receiver.

17. A control method for an image processing apparatus for recognizing a predetermined scene in a picked-up image, the control method comprising:
receiving a picked-up image obtained by picking up an image of a first object;
generating distortion information indicating distortion, relative to a known shape, in a shape of the first object in the received picked-up image;
calculating a target position in the picked-up image;
determining a target region based on the generated distortion information and the calculated target position;
based on the determined target region, generating a target region image from the picked-up image;
scaling the generated target region image to a predetermined size; and
performing predetermined recognition based on the scaled target region image, wherein
in determining the target region, a target region size that is a size of the target region corresponding to an actual size, is determined based on the generated distortion information and the calculated target position.

18. A non-transitory computer-readable storage medium storing instructions that, when executed by a computer, cause the computer to implement a control method for an image processing apparatus for recognizing a predetermined scene in a picked-up image, the control method including:
receiving a picked-up image obtained by picking up an image of a first object;
generating distortion information indicating distortion, relative to a known shape, in a shape of the first object in the received picked-up image;
calculating a target position in the picked-up image;
determining a target region based on the generated distortion information and the calculated target position;
based on the determined target region, generating a target region image from the picked-up image;
scaling the generated target region image to a predetermined size; and
performing predetermined recognition based on the scaled target region image, wherein
in determining the target region, a target region size that is a size of the target region corresponding to an actual size, is determined based on the generated distortion information and the calculated target position.
